(19) United States
(12) Patent Application Publication
(10) Pub. No.: US 2022/0415336 A1
(43) Pub. Date: Dec. 29, 2022

(54) VOICE COMMUNICATION APPARATUS AND HOWLING DETECTION METHOD

(71) Applicant: PANASONIC INTELLECTUAL PROPERTY MANAGEMENT CO., LTD., Osaka (JP)

(72) Inventor: Shinichi TAKAYAMA, Fukuoka (JP)

(73) Assignee: PANASONIC INTELLECTUAL PROPERTY MANAGEMENT CO., LTD., Osaka (JP)

(21) Appl. No.: 17/850,575

(22) Filed: Jun. 27, 2022

(30) Foreign Application Priority Data
Jun. 28, 2021 (JP) 2021-107009
Mar. 4, 2022 (JP) 2022-033838

(51) Int. Cl. G10L 21/02; G08B 5/22; H04L 65/403

(52) U.S. Cl. CPC G10L 21/02; G08B 5/22; H04L 65/403

(57) ABSTRACT

A voice communication apparatus includes a communication unit configured to communicate with one or more another terminals via a network, a voice signal processing unit configured to acquire a first voice signal collected from a voice input terminal, acquire a second voice signal output from another terminal, and detect whether there is howling based on the first and second voice signals, a control unit configured to determine whether a device connected to the voice input terminal or a device connected to the voice output terminal is a howling cause based on a detection result of the voice signal processing unit, and an alert notification unit configured to generate and output an alert screen when the control unit determines that the device connected to the voice input terminal or the device connected to the voice output terminal is the howling cause.

### CROSS-REFERENCE TO RELATED APPLICATIONS

This application is based on and claims priority under 35 USC 119 from Japanese Patent Applications No. 2021-107009 filed on Jun. 28, 2021 and No. 2022-033838 filed on Mar. 4, 2022, the contents of which are incorporated herein by reference.

### TECHNICAL FIELD

The present disclosure relates to a voice communication apparatus and a howling detection method.

### BACKGROUND ART

Patent Literature 1 discloses a server that controls an output of voice data of a plurality of electronic devices. The server divides the plurality of electronic devices into at least a first group and a second group. When a first electronic device belonging to the first group acquires voice data, the server controls the first electronic device so that voice data is output from a second electronic device belonging to the second group and executes a control such that voice data is not output from an electronic device other than the first electronic device belonging to the first group. When a third electronic device is newly connected, the server determines a group to which the third electronic device belongs based on a response signal from the third electronic device to voice signals transmitted from the first electronic device and the second electronic device, and controls a microphone provided in the third electronic device to be turned on and a speaker provided in the third electronic device to be turned off.

### CITATION LIST

### Patent Literature

Patent Literature 1: JP-2004-23722-A

### SUMMARY OF INVENTION

Here, in a web conference system, it is assumed to prevent howling that may occur when a plurality of PCs each including a microphone and a speaker are arranged in an own base and are connected to a partner base. In the configuration of Patent Literature 1, when the plurality of PCs are connected in the same base, a microphone of each PC that is set as a Child device is forcibly turned on, and a speaker of each PC is forcibly turned off Therefore, in a web conference system using the configuration of Patent Literature 1, a PC may be set against a user intention, and the degree of freedom regarding setting of a microphone and a speaker provided in each of the plurality of PCs in the same base is low,

The present disclosure is devised in view of the above-described circumstances in the related art, and an object of the present disclosure is to provide a voice communication apparatus and a howling detection method for specifying and presenting a cause of howling that may occur between the voice communication apparatus and another voice input and output device.

The present disclosure provides a voice communication apparatus configured to be connected to a voice conference participated by a plurality of terminals. In each of the terminals, a voice input and a voice output are arbitrarily controlled to ON/OFF by a user operation. The voice communication apparatus includes: a communication unit configured to communicate with one or more another terminals via a network; a microphone configured to acquire a first voice signal based on speech of a speaker; a speaker configured to output a second voice signal from the other terminal received by the communication unit; a voice signal processing unit configured to detect whether there is howling based on the first voice signal and the second voice signal; a control unit configured to determine whether the microphone or the speaker is a howling cause; and an alert notification unit configured to generate and output an alert screen when the control unit determines that the microphone or the speaker is the howling cause.

Further, the present disclosure provides a voice communication apparatus configured to be connected to a voice conference in which a plurality of terminals participate. In each of the terminals, a voice input and a voice output being freely controlled to ON/OFF by a user operation. The voice communication apparatus includes: a communication unit configured to communicate with one or more another terminals via a network; a voice signal processing unit configured to acquire a first voice signal collected from a voice input terminal, acquire a second voice signal that is output from another terminal and is input to a voice output terminal, and detect whether there is howling based on the first voice signal and the second voice signal; a control unit configured to determine whether a device connected to the voice input terminal or a device connected to the voice output terminal is a howling cause based on a detection result of the voice signal processing unit; and an alert notification unit configured to generate and output an alert screen when the control unit determines that the device connected to the voice input terminal or the device connected to the voice output terminal is the howling cause.

Further, the present disclosure provides a howling detection method to be executed by a voice communication apparatus configured to be connected to a voice conference participated by a plurality of terminals participate. In each of the terminals, a voice input and a voice output are arbitrarily controlled to ON/OFF by a user operation. The howling detection method includes the steps of: communicating with one or more another terminals via a network; acquiring, by a microphone, a first voice signal based on speech of a speaker; outputting, by a speaker, a second voice signal obtained by the other terminal; detecting whether there is howling based on the first voice signal and the second voice signal; determining whether the microphone or the speaker is a howling cause; and generating and outputting an alert screen when it is determined that the microphone or the speaker is the howling cause.

Furthermore, the present disclosure provides a howling detection method to be executed by a voice communication apparatus configured to be connected to a voice conference in which a plurality of terminals participate, in each of the terminals, a voice input and a voice output being freely controlled to ON/OFF by a user operation. The howling detection method includes the steps of: communicating with one or more another terminals via a network; acquiring a first voice signal collected from a device connected to a voice input terminal, acquiring a second voice signal that is output from another terminal and is input to a device connected to a voice output terminal, and detecting whether there is howling based on the first voice signal and the second voice signal; determining whether the device connected to the voice input terminal or the device connected to the voice output terminal is a howling cause; and generating and outputting an alert screen when it is determined that the device connected to the voice input terminal or the device connected to the voice output terminal is the howling cause.

According to the present disclosure, it is possible to specify and present a cause of howling that may occur between a voice communication apparatus and another voice input and output device.

### BRIEF DESCRIPTION OF DRAWINGS

FIG. 1 is a diagram showing a system configuration example of a web conference system according to a first embodiment.

FIG. 2 is a block diagram showing a hardware configuration example of a PC according to the first embodiment.

FIG. 3 is a diagram showing an operation outline example of the PC according to the first embodiment.

FIG. 4 is a block diagram showing a first configuration example of a voice signal processing unit.

FIG. 5 is a diagram showing an example of frequency characteristics of a microphone signal and a speaker signal.

FIG. 6 is a block diagram showing a second configuration example of the voice signal processing unit.

FIG. 7 is a block diagram showing a third configuration example of the voice signal processing unit.

FIG. 8 is a block diagram showing a fourth configuration example of the voice signal processing unit.

FIG. 9 is a flowchart showing an overall operation procedure example of the PC according to the first embodiment.

FIG. 10 is a flowchart showing an operation procedure example of a peak determination processing as a subroutine.

FIG. 11 is a flowchart showing an example of a howling cause determination procedure when the PC according to the first embodiment is not linked with another terminal.

FIG. 12 is a flowchart showing an example of a howling cause determination procedure when the PC according to the first embodiment is linked with another terminal.

FIG. 13 is a flowchart showing an example of a cause flag determination procedure of the PC according to the first embodiment.

FIG. 14 is a flowchart showing an example of a cause flag determination procedure of the PC according to the first embodiment.

FIG. 15 is a flowchart showing an example of a cause flag determination procedure of the PC according to the first embodiment.

FIG. 16 is a flowchart showing an example of a first time main and sub determination procedure of the PC according to the first embodiment.

FIG. 17 is a diagram showing a first use case of the web conference system according to the first embodiment.

FIG. 18 is a diagram showing a second use case of the web conference system according to the first embodiment.

FIG. 19 is a flowchart showing an example of twice and subsequent first main and sub determination procedures of the PC according to the first embodiment.

FIG. 20 is a diagram showing details of the first use case of the web conference system according to the first embodiment.

FIG. 21 is a diagram showing details of the first use case of the web conference system according to the first embodiment.

FIG. 22 is a flowchart showing an example of twice and subsequent second main and sub determination procedures of the PC according to the first embodiment.

FIG. 23 is a diagram showing details of the second use case of the web conference system according to the first embodiment.

FIG. 24 is a diagram showing details of the second use case of the web conference system according to the first embodiment.

FIG. 25 is a flowchart showing an example of a procedure for detecting another terminal in the same base as the PC according to the first embodiment.

FIG. 26 is a diagram showing an example of speaker signals of two PCs in the same base.

FIG. 27 is a diagram showing an example of microphone signals of two PCs in the same base.

### DESCRIPTION OF EMBODIMENTS

Hereinafter, embodiments specifically disclosing a voice communication apparatus and a howling detection method according to the present disclosure will be described in detail with reference to the drawings as appropriate. Unnecessarily detailed description may be omitted. For example, detailed description of a well-known matter or repeated description of substantially the same configuration may be omitted. This is to avoid unnecessary redundancy in the following description and to facilitate understanding of those skilled in the art. The accompanying drawings and the following description are provided for a thorough understanding of the present disclosure for those skilled in the art, and are not intended to limit the subject matter in the claims.

First, problems to be solved by a web conference system 100 will be briefly described before describing a configuration of the web conference system 100 according to a first embodiment. It is assumed that a plurality of personal computers (PC) are connected to the same network in an own base (for example, the same space such as the same conference room), and a web conference is performed between the plurality of PCs and a PC in a partner base connected to the network.

In this case, for example, when both a microphone and a speaker provided in each of the plurality of PCs in the own base are turned on, howling occurs. There is a problem in that, for example, a voice signal output from a speaker of a first PC in the own base is collected by a microphone of a second PC in the same own base, and an echo of the voice signal continues in a loop shape, thereby causing unpleasant howling. When the howling occurs, a progress of the web conference does not proceed as expected, and a work efficiency may deteriorate.

Therefore, it is necessary to detect the occurrence of the howling in real time and interrupt the loop by blocking a voice signal input to a speaker and output from the speaker (hereinafter, may be referred to as a “speaker signal”) or a voice signal collected by a microphone (hereinafter, may be referred to as a “microphone signal”).

Therefore, the following first embodiment describes an example of a computer (PC) serving as a voice communication apparatus that includes one computer provided with a microphone and a speaker and prevents the occurrence of howling that may occur between the computer (PC) and another PC including a microphone and a speaker provided in the same base in the above-described web conference system.

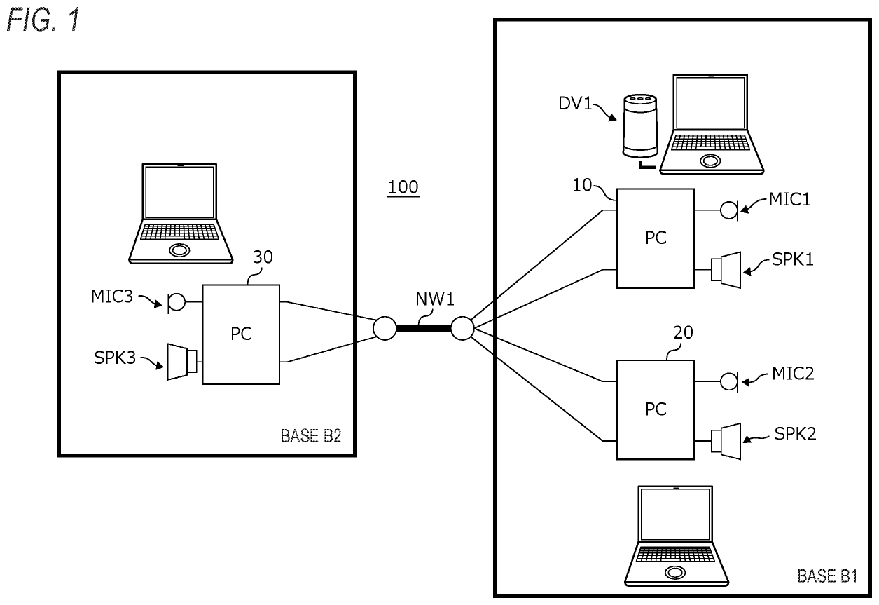

FIG. 1 is a diagram showing a system configuration example of the web conference system 100 according to the first embodiment. The web conference system 100 includes a plurality of PCs 10, 20, and 30 that are connected to one another via a network NW1. The PC 10 is arranged in a base B1 where the web conference system 100 is used, and includes a microphone MIC1 and a speaker SPK1. Similar to the PC 10, the PC 20 is arranged in the base B1 where the web conference system 100 is used, and includes a microphone MIC2 and a speaker SPK2. The PC 30 is arranged in a base B2 where the web conference system 100 is used, and includes a microphone MIC3 and a speaker SPK3. That is, the PCs 10 and 20 are arranged in the same base B1 (an own base), and the PC 30 is arranged in another base B2 (a partner base). Each of the bases B1 and B2 may be, for example, a space such as a conference room or a meeting corner in a company, and the base is not limited to a specific configuration of space. The network NW1 may be a wired network, a wireless network, or a combination of a wired network and a wireless network. The wired network may be, for example, a wired local area network (LAN) represented by Ethernet (registered trademark), and a type of the wired network is not particularly limited. On the other hand, the wireless network may be, for example, a wireless LAN represented by Wi-Fi (registered trademark), and a type of the wireless network is not particularly limited.

Instead of the microphone MIC1 and the speaker SPK1 incorporated in the PC 10, an external speaker phone DVI integrally provided with configurations and functions of the microphone and the speaker may be connected to the PC 10 for use. That is, the speaker phone DV1 has both the function of the microphone MIC1 that collects a voice based on an utterance of an operator (a speaker) of the PC 10 and the function of the speaker SPK.1 that outputs a voice from the PCs 20 and 30 other than the PC 10. Although FIG. 1 shows an example in which the external speaker phone DV1 is connected to the PC 10, the external speaker phone DV1 may be connected to the PC 30 other than the PC 10. The PC 10 may include a voice input terminal for inputting a voice, and may collect a voice from a device (for example, a microphone, a speaker phone, or the like) connected to the voice input terminal. The PC 10 may include a voice output terminal for outputting a voice, and may output a voice from a device (for example, a speaker, a speaker phone, or the like) connected to the voice output terminal.

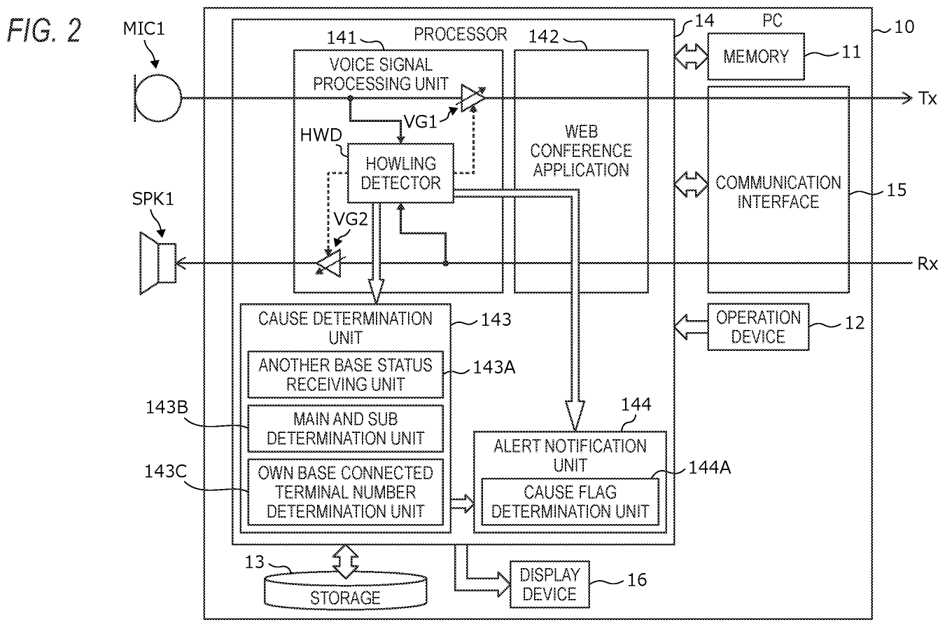

FIG. 2 is a block diagram showing a hardware configuration example of the PC 10 according to the first embodiment. FIG. 2 shows the PC 10 as an example among the PCs 10, 20, and 30 show) in FIG. 1, and the PCs 20 and 30 have the same configuration as the PC 10 (see FIG. 2). Therefore, in the description of FIG. 2, the “PC 10” may be read as the “PC 20” or the “PC 30”. The “PC 20” may be read as the “PC 30” or the “PC 10”, and the “PC 30” may be read as the “PC 10” or the “PC 20”.

The PC 10 includes a memory 11, an operation device 12, a storage 13, a processor 14, a communication interface 15, the microphone MIC1, and the speaker SPK1. The microphone MIC1 may be connected via the voice input terminal provided in the PC 10. The speaker SPK1 may be connected via the voice output terminal provided in the PC 10. These units are connected to one another via an internal bus (not shown) or the like such that data or signals can be transmitted and received.

The memory 11 includes at least a random access memory (RAM) serving as a work memory used when, for example, the processor 14 executes various processings, and a read only memory (ROM) that stores a program (including a program of a web conference application 142) for defining various processings to be executed by the processor 14 and data used during the execution of the program. Data or information generated or acquired by the processor 14 is temporarily stored in the RAM. The program for defining the various processings to be executed by the processor 14 and the data used during the execution of the program are written in the ROM.

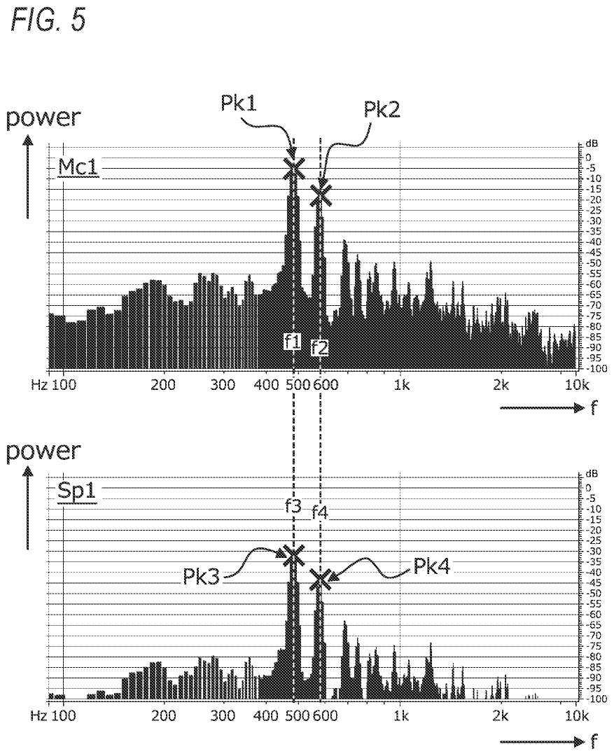

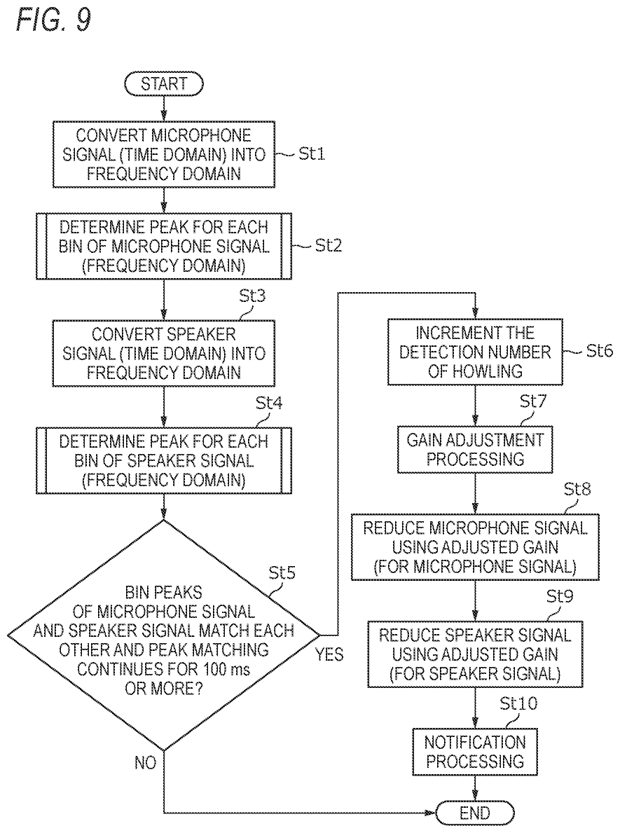

For example, the memory 11 stores a threshold A and a threshold B. The threshold A is a value used by the processor 14 to determine a protrusion degree relative to a surrounding bin (see FIG. 9) in a frequency domain (to be described later) of the microphone signal or the speaker signal, and the threshold A is a fixed value. The threshold B is a value used to prevent the occurrent of howling from being erroneously determined when power of the microphone signal or the speaker signal in the frequency domain (to be described later) is small, and the threshold B is a fixed value different from the threshold A. For example, a microphone signal Mc1 in a frequency domain shown in FIG. 5 has a plurality of peaks per 1000 Hz (1 kHz). Since the plurality of peaks are not peaks based on howling, the threshold B is provided for preventing the plurality of peaks from being erroneously detected as peaks based on howling.

For example, the memory 11 stores current values (for example, initial values) of a first gain and a second gain set in variable amplifiers VG1 and VG2. However, when the occurrence of howling is detected by a howling detector HWD to be described later, at least one of the first gain and the second gain is adjusted to be lowered, and thus the memory 11 may store at least one of the first gain and the second gain. The first gain and the second gain before the adjustment may be discarded from the memory 11, or may be continuously stored in the memory 11.

In addition, for example, the memory 11 temporarily stores the number of detection times of howling detected by the howling detector HWD of a voice signal processing unit 141 of the processor 14 during a web conference using the web conference system 100. Since the number of detection times indicates the number of times the howling is counted by the howling detector HWD during the web conference using the web conference system 100, the number of detection times is reset to zero when, for example, the web conference is ended.

The operation device 12 is configured with, for example, at least one device such as a mouse, a keyboard, a touch pad, and a touch panel. The operation device 12 receives an input operation performed by an operator who uses the PC 10 (that is, a user of the web conference system 100), and inputs a signal corresponding to the input operation to the processor 14. In the following description, the operator who uses the PC 10 may be referred to as a “PC 10 user”, an operator who uses the PC 20 may be referred to as a “PC 20 user”, and an operator who uses the PC 30 may be referred to as a “PC 30 user” for convenience.

The storage 13 is configured with a storage medium such as a flash memory, a hard disk drive (HDD), or a solid state drive (SSD). The storage 13 stores data or information generated or acquired by the processor 14 regardless of whether power of the PC 10 is turned on.

The processor 14 is configured with a semiconductor chip equipped with at least one electronic device such as a central processing unit (CPU), a digital signal processor (DSP), a graphical processing unit (GPU), and a field programmable gate array (FPGA). The processor 14 functions as a controller that controls an overall operation of the PC 10, and executes a control processing for controlling operations of units of the PC 10, a data input and output processing to each of the units of the PC 10, a data calculation processing, and a data storage processing. The processor 14 can implement functions of the voice signal processing unit 141, the web conference application 142, a cause determination unit 143, and an alert notification unit 144 by using a program and data stored in the ROM of the memory 11. The processor 14 uses the RAM of the memory 11 during an operation of the processor 14, and temporarily stores data or information generated or acquired by the processor 14 in the RAM of the memory 11,

The voice signal processing unit 141 includes at least the howling detector HWD and the variable amplifiers VG1 and VG2. The voice signal processing unit 141 inputs, to the howling detector HWD, a voice signal (that is, a microphone signal serving as an example of a first voice signal in a time domain) of the PC 10 user after the voice signal is collected by the microphone MIC1 and before the voice signal is input to the web conference application 142 and a voice signal (that is, a speaker signal serving as an example of a second voice signal in a time domain) after the voice signal is processed by the web conference application 142 and before the voice signal is input to the speaker SPK1. Although not shown, the voice signal processing unit 141 includes a first voice input unit that acquires a voice signal (that is, a voice signal to be input to the howling detector HWD) collected by the microphone MIC1, a first voice output unit that outputs a voice signal (that is, a voice signal amplified or reduced by the variable amplifier VG1) to be output to the web conference application 142, a second voice input unit that acquires a voice signal (that is, a voice signal to be input to the howling detector HWD) received via the web conference application 142, and a second voice output unit that outputs a voice signal (that is, a voice signal amplified or reduced by the variable amplifier VG2) to be output to the speaker SPK1. The voice signal processing unit 141 includes a voice input terminal to which a voice input device such as the microphone MIC1 is connected, and a voice output terminal to which a voice output device such as the speaker SPK1 is connected. The microphone MIC1 is connected to the voice input terminal, and a voice signal from the microphone MIC1 is input to the voice signal processing unit 141. The speaker SPK1 is connected to the voice output terminal and outputs a voice signal from the voice signal processing unit 141.

The voice signal processing unit 141 causes the howling detector HAD to detect whether howling occurs in the web conference system 100 based on a correlation between frequency characteristics of the input microphone signal and the input speaker signal or the frequency characteristics of one of the input microphone signal and the input speaker signal. In response to the detection of the howling, the voice signal processing unit 141 causes the variable amplifiers VG1 and VG2 to adjust at least one of the first gain for reducing the microphone signal in the time domain described above and the second gain for weakening the speaker signal in the time domain described above. For example, the voice signal processing unit 141 adjusts the second gain to be larger than the first gain. Accordingly, since a speaker signal output from the PC 10 is weakened greater than a microphone signal to be transmitted to the other PCs 20 and 30, the howling in the web conference system 100 can be effectively prevented. A configuration example of the howling detector HWD will be described later with reference to FIGS. 5 to 8.

When the howling detector HWD detects that howling occurs in the web conference system 100, the voice signal processing unit 141 generates a control signal indicating that the occurrence of howling is detected and outputs the control signal to the cause determination unit 143.

The web conference application 142 serving as an example of a voice communication application is an application to be executed by the processor 14 during a web conference using the web conference system 100, and is installed in each of the PCs 10, 20, and 30 provided in the web conference system 100 so that the PCs 10, 20, and 30 can execute the web conference application 142. The web conference application 142 is, for example, an application called Microsoft Teams (registered trademark) provided by Microsoft Corporation or an application called Zoom (registered trademark) provided by Zoom Video Communications, and the web conference application 142 is not limited to thereto. The web conference application 142 executes various signal processings such as amplifying and filtering a microphone signal based on a voice collected by the microphone MIC1, and outputs the microphone signal to the communication interface 15. The web conference application 142 executes various signal processings such as amplifying and filtering a voice signal (a speaker signal) received by the communication interface 15, and outputs the voice signal to the voice signal processing unit 141.

The cause determination unit 143 serving as an example of a control unit includes at least another base status receiving unit 143A, a main and sub determination unit 143B, and an own base connected terminal number determination unit 143C. The cause determination unit 143 executes a howling cause determination processing based on a control signal output from the voice signal processing unit 141. The cause determination unit 143 executes a main and sub determination processing or the howling cause determination processing based on own terminal status information (that is, terminal information of the PC 10), another terminal status information that is related to at least one another PC arranged in the same base and is output from the communication interface 15, another base status information transmitted from at least one another PC arranged in a base different from the base in which the PC 10 is arranged, another terminal status information transmitted from another PC (that is, another terminal) arranged in an own base, or the like. The cause determination unit 143 outputs a howling cause determination processing result to the alert notification unit 144.

Here, the own terminal status information is information related to an own terminal (for example, the PC 10), and is, for example, information related to whether howling occurs in the PC 10, information related to a howling cause, information related to whether a speaker phone is connected, or the like. Similarly, the other terminal status information is information related to another PC arranged in the same base as the PC 10, and is, for example, information related to whether howling occurs (is detected) in the other PC, information related to a howling cause, information related to whether a speaker phone is connected, and the like. The other base status information is information related to whether howling occurs (is detected) in at least one PC arranged in the other base, information related to a howling cause, and the like.

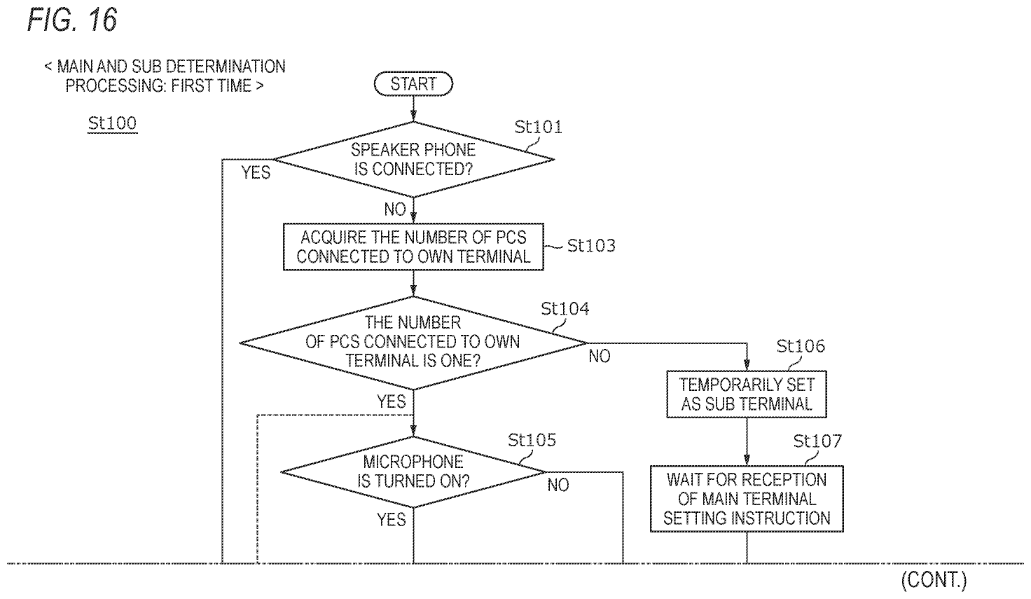

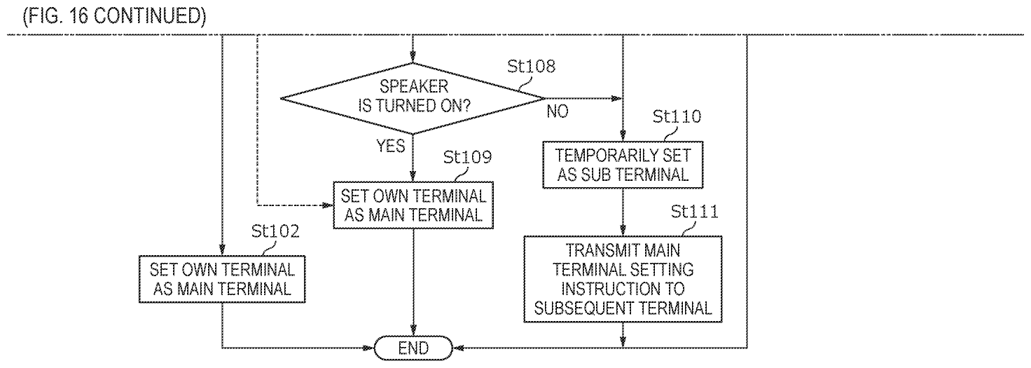

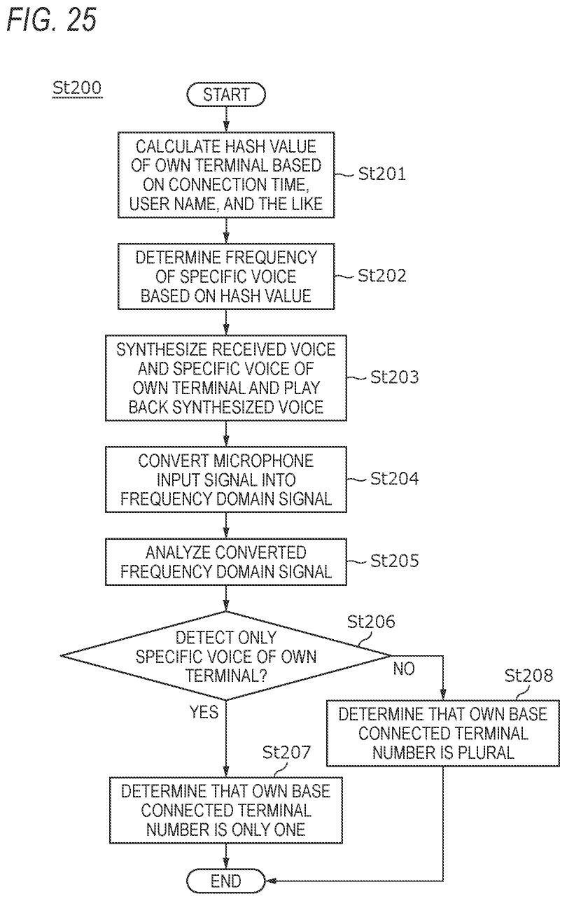

The other base status receiving unit 143A periodically or irregularly acquires the other base status information output from the communication interface 15, the other terminal status information in the own base, or the like. The main and sub determination unit 143B determines whether the PC 10 is a main terminal or a sub terminal in the own base. A main and sub method of the PC 10 to be executed by the main and sub determination unit 143B will be described later with reference to FIGS. 16 to 24. The own base connected terminal number determination unit 1430 determines whether the number of PCs connected to a venue (an address) of a web conference provided by the web conference system 100 is only one in the own base (that is, in the same base) where the PC 10 is arranged. A processing of determining the number of PCs in the own base is executed by the own base connected terminal number determination unit 143C and will be described later with reference to FIGS. 25 to 27.

Here, the main terminal is any one PC among a plurality of PCs arranged in each base, and is a terminal in which both a microphone and a speaker are set to ON, and transmission of a voice signal to another base and reception of a voice signal from another base are executed by the main terminal. The sub terminal is a PC other than the PC that is set as the main terminal among a plurality of PCs arranged in each base. It is desirable that both a microphone and a speaker of the sub terminal are set to OFF, but the present invention is not limited thereto. When there is only one PC arranged in the same base, this PC is set as the main terminal.

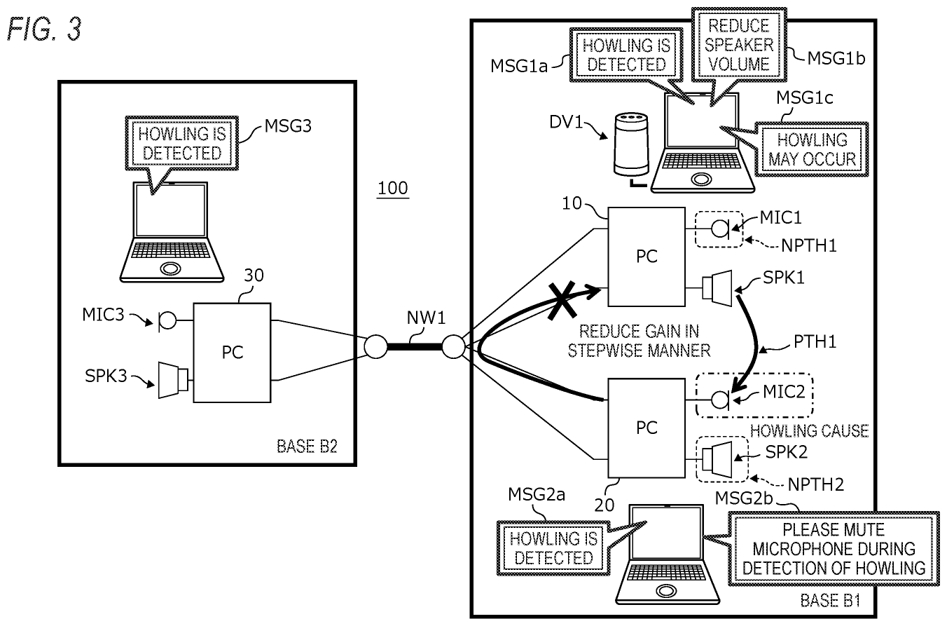

The alert notification unit 144 includes at least a cause flag determination unit 144A. The cause flag determination unit 144A turns on a cause flag of the microphone MIC1 or the speaker SPK1 based on a howling cause determination result output from the cause determination unit 143. The alert notification unit 144 generates an alert screen MSG2b (see FIG. 3) indicating contents of a user operation on a target (the microphone MIC1 or the speaker SPK1) of which the cause flag is turned on, and outputs the alert screen MSG2b to a display device 16 and displays the alert screen MSG2b. As a result, the PC 10 can present a howling cause and a user operation for eliminating the howling to a user based on the alert screen MSG2b displayed on the display device 16.

The communication interface 15 serving as an example of a communication unit is configured with, for example, a communication device capable of transmitting data or information to and receiving data or information from the network NW1. The communication interface 15 transmits, for example, data or the information (for example, a voice signal Tx of the PC 10 user processed by the web conference application 142) generated or acquired by the processor 14 to the other PCs 20 and 30 via the network NW1. The communication interface 15 receives data or information (for example, a voice signal Rx processed by a web conference application installed in the PC 20 or the PC 30 based on an utterance of the PC 20 user or the PC 30 user) transmitted from the other PCs 20 and 30, and inputs the data or the information to the processor 14. The communication interface 15 transmits the own terminal status information to and receives the other terminal status information, the other base status information, or the like from at least one another PC arranged in the same base or arranged in another base. For example, the communication interface 15 transmits the own terminal status information generated by the cause determination unit 143 to another PC arranged in the same base or arranged in another base, and receives the other terminal status information, the other base status information, or the like transmitted from the other PC arranged in the same base or arranged in another base.

The display device 16 is configured with, for example, a liquid crystal display (LCD) or an organic electroluminescence (EL) display, and displays data or the information (for example, display screens MSG1a and MSG1b shown in FIG. 3, or an alert message MSG1c) generated or acquired by the processor 14.

The microphone MIC1 collects a voice based on an utterance (for example, an utterance during a web conference using the web conference system 100) of the PC 10 user, and inputs a voice signal obtained by collecting the voice to the processor 14. Specifically, the voice signal from the microphone MIC1 is input to the voice signal processing unit 141 of the processor 14.

The speaker SPK1 acoustically outputs a voice signal (for example, a voice signal based on the collection of a voice uttered by the PC 20 user or the PC 30 user during a web conference using the web conference system 100) processed by the processor 14. A part of the voice signal output from the speaker SPK1 goes around (that is, is diffracted) and is collected by the microphone MIC2 provided in the PC 20 (see FIG. 3).

Next, an operation outline example of the PC 10 according to the first embodiment will be described with reference to FIG. 3. FIG. 3 is a diagram showing an operation outline example of a PC according to the first embodiment. FIG. 3 shows a use case in which the PC 10 detects howling among the PCs 10, 20, and 30 provided in the web conference system 100, and the PC 20 may detect the howling instead of the PC 10. Among the elements shown in FIG. 3, those having the same configuration as the corresponding elements shown in FIG. 1 are denoted by the same reference numerals, description thereof will be simplified or omitted, and different contents will be described.

In FIG. 3, in a case where each of the PCs 10, 20, and 30 is connected to the network NW1 and a web conference using the web conference system 100 is started, unpleasant howling occurs when the microphones MIC1 and MIC2 and the speakers SPK1 and SPK2 of the PCs 10 and 20 arranged in the same base B1 are turned on. For example, the howling occurs in a howling occurrence path PTH1 because the microphone MIC2 provided in the PC 20 is turned on.

That is, as shown in FIG. 3, a part of a voice signal output from the speaker SPK1 of the PC 10 goes around the microphone MIC2 of the PC 20 present in the vicinity of the PC 10 and is collected by the microphone MIC2, so that an echo of the voice signal continues in a loop shape (for example, the howling occurrence path PTH1 is formed), Which causes howling. Therefore, for example, When the howling occurs due to the formation of the howling occurrence path PTH1, the speaker SPK1 of the PC 10 and the microphone MIC2 of the PC 20 are located on the howling occurrence path PTH1, while the microphone MIC1 of the PC 10 and the speaker SPK2 of the PC 20 are respectively located on howling non-occurrence paths NPTH1 and NPTH2.

The processor 14 of the PC 10 according to the first embodiment can detect whether there is howling based on a correlation between frequency characteristics of a microphone signal obtained by collecting a voice by the microphone MIC1 and frequency characteristics of a speaker signal output from the speaker SPK1 (details will be described later). When the processor 14 of the PC 10 detects that the howling Occurs, the processor 14 of the PC 10 executes a processing (a gain adjustment processing to be described later) of reducing a gain to be multiplied by at least one of the microphone signal and the speaker signal in a stepwise manner in order to weaken at least one of the microphone signal in a time domain based on a voice collected by the microphone MIC1 and the speaker signal in a time domain before the speaker signal is input to the speaker SPK1. Accordingly, the howling is gradually prevented from occurring.

When the processor 14 of the PC 10 detects that howling occurs, the processor 14 of the PC 10 displays, on the display device 16, the display screen MSG1a for notifying the occurrence of the howling or the display screen MSG1b for notifying that a volume of a voice signal output from the speaker SPK1 is reduced. The PC 10 may display both the display screen MSG1a and the display screen MSG1b on the display device 16. As a result, the PC 10 user can visually know via the display device 16 that howling occurs during a web conference using the web conference system 100. When the PC 10 determines that the PC 10 user is a howling cause and a device (the microphone MIC1 or the speaker SPK1) in an OFF state is turned on, the PC 10 displays the alert message MSG1c for warning re-occurrence of howling on the display device 16. As a result, the PC 10 user can visually know via the display device 16 that howling may occur again due to an operation of turning on the device (the microphone MIC1 or the speaker SPK1) by a user.

When the PC 10 detects howling, the processor 14 of the PC 10 may transmit a display instruction of the display screens MSG2a and MSG3 for notifying the occurrence of the howling to the PCs 20 and 30 via the network NW1. The PCs 20 and 30 generate the display screens MSG2a and MSG3 based on the display instruction from the PC 10 and display the display screens MSG2a and MSG3 on a display device. Each of the display screens MSG2a and MSG3 may be received by each of the PCs 20 and 30 from the PC 10 together with the above-described display instruction generated by the PC 10. As a result, each of the PC 20 user and the PC 30 user can visually know that howling occurs during a web conference using the web conference system 100 via the display device 16 corresponding to each of the PCs 20 and 30.

Similarly, when the PC 10 detects howling and the microphone MIC2 of the PC 20 may be determined to be a howling cause, the processor 14 of the PC 10 may transmit, to the PC 20 via the network NW1, a display instruction of the alert screen MSG2b for instructing contents of a user operation on the microphone MIC2 which is the howling cause. The PC 20 generates the display screen MSG2a based on the display instruction transmitted from the PC 10 and displays the display screen MSG2a on a display device. The display screen MSG2a may be generated by the PC 10 and received by the PC 20 from the PC 10 together with the display instruction described above. As a result, the PC 20 user can visually know via the display device 16 corresponding to the PC 20 that howling occurs during a web conference using the web conference system 100.

When the processor 14 of the PC 20 detects howling, the PC 20 generates the display screen MSG2 and displays the display screen MSG2 on the display device 16. The PC 20 causes the cause determination unit 143 in the processor to determine that a howling cause is the microphone MIC2, causes the alert notification unit 144 to generate the alert screen MSG2b, and displays the alert screen MSG2b on the display device 16. As a result, the PC 20 user can visually know that howling occurs during a web conference using the web conference system 100 through the display screen MSG2 displayed on the display device 16 corresponding to the PC 20, and can visually know that a howling cause is the microphone MIC2 and a user operation of muting the microphone MIC2 is required to eliminate the howling.

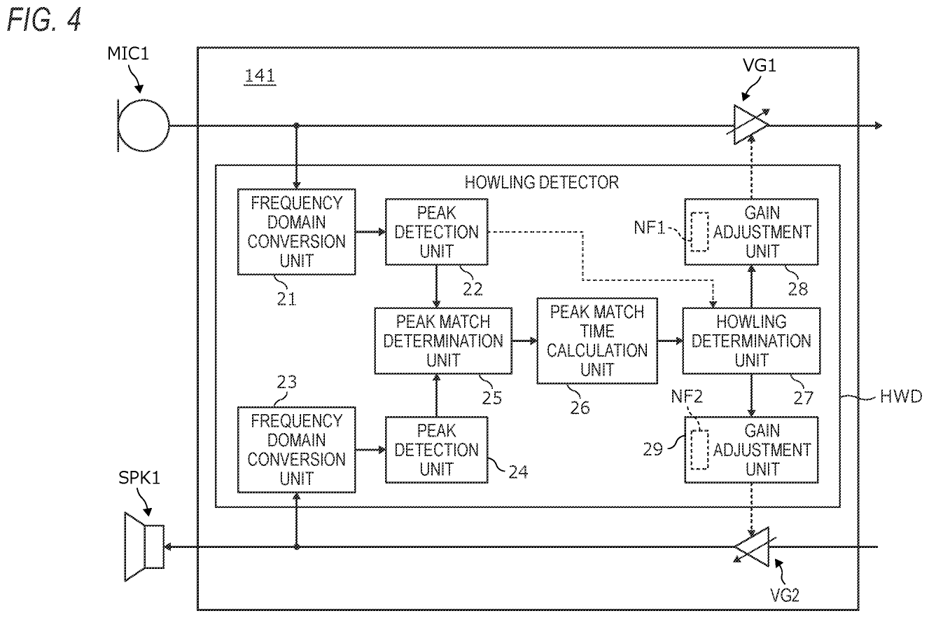

Next, a configuration example of the howling detector HWD provided in the PC 10 according to first embodiment will be described with reference to FIGS. 4 and 5. FIG. 4 is a block diagram showing a first configuration example of a voice signal processing unit, FIG. 5 is a diagram showing an example of frequency characteristics of a microphone signal and a speaker signal. A horizontal axis in FIG. 5 represents a frequency, and a vertical axis in FIG. 5 represents power (for example, spectrum) of each signal. Among the elements shown in FIG. 4, those having the same configuration as the corresponding elements shown in FIG. 2 are denoted by the same reference numerals, description thereof will be simplified or omitted, and different contents will be described.

The voice signal processing unit 141 includes at least the howling detector HWD and the variable amplifiers VG1 and VG2. The howling detector HWD includes a frequency domain conversion unit 21, a peak detection unit 22, a frequency domain conversion unit 23, a peak detection unit 24, a peak match determination unit 25, a peak match time calculation unit 26, a howling determination unit 27, and gain adjustment units 28 and 29. The howling detector HWD temporarily stores an input microphone signal and an input speaker signal in the memory 11, and executes a corresponding processing in each of the units constituting the howling detector HWD in cooperation with the memory 11.

The frequency domain conversion unit 21 converts, for example, a microphone signal in a time domain into the microphone signal Mc1 in a frequency domain by executing a Fourier transform on the microphone signal from the microphone MIC1, and outputs the microphone signal Mel to the peak detection unit 22. In the configuration example of the voice signal processing unit 141 shown in FIG. 4, the microphone signal from the microphone MIC1 before the microphone signal is amplified or weakened by the variable amplifier VG1 is input to the frequency domain conversion unit 21.

Based on frequency characteristics of the microphone signal Mc1 in the frequency domain from the frequency domain conversion unit 21, the peak detection unit 22 detects first peak frequencies 11 and f2 (see FIG. 5) at which the power of the microphone signal Mc1 obtained for each bin (see FIG. 9) of the microphone signal Mel has a maximum value (that is, peaks Pk1 and Pk2), and outputs a detection result to the peak match determination unit 25. For example, FIG. 5 shows that the first peak frequency f1 is about 500 Hz and the first peak frequency f2 is about 600 Hz.

The frequency domain conversion unit 23 converts, for example, a speaker signal in a time domain into a speaker signal Sp1 in a frequency domain by executing a Fourier transform on the speaker signal before the speaker signal is input to the speaker SPK1, and outputs the speaker signal Sp1 to the peak detection unit 24. In the configuration example of the voice signal processing unit 141 shown in FIG. 4, the speaker signal after being amplified or weakened by the variable amplifier VG2 is input to the frequency domain conversion unit 23.

Based on frequency characteristics of the speaker signal Sp1 in the frequency domain from the frequency domain conversion unit 23, the peak detection unit 24 detects second peak frequencies f3 and f4 (see FIG. 5) at which power of the speaker signal Sp1 has a maximum value (that is, peaks Pk3 and Pk4), and outputs a detection result to the peak match determination unit 25. For example, FIG. 5 shows that the second peak frequency f3 is about 500 Hz and the second peak frequency f4 is about 600 Hz.

The peak match determination unit 25 determines whether the first peak frequency (for example, f1 and f2 shown in FIG. 5) detected by the peak detection unit 22 matches the second peak frequency (for example, 13 and f4 shown in FIG. 5) detected by the peak detection unit 24 based on the detection results from the peak detection units 22 and 24. The peak match determination unit 25 outputs a determination result to the peak match time calculation unit 26. In FIG. 5, the first peak frequency f1 is equal to the second peak frequency f3, and the first peak frequency 12 is equal to the second peak frequency f4.

When the determination result from the peak match determination unit 25 indicates that the first peak frequency matches the second peak frequency, the peak match time calculation unit 26 determines whether a time during which the peaks match each other is continuous for a predetermined time (for example, 100 milliseconds) or more. The predetermined time is not limited to 100 milliseconds. The peak match time calculation unit 26 outputs a determination result to the howling determination unit 27.

The howling determination unit 27 determines Whether howling occurs based on the determination result from the peak match time calculation unit 26. Specifically, the howling determination unit 27 determines that howling occurs when it is determined that the first peak frequency detected by the peak detection unit 22 and the second peak frequency detected by the peak detection unit 24 match each other and the match time is continuous for the predetermined time or more. The howling determination unit 27 outputs the determination result to each of the gain adjustment units 28 and 29.

When the determination result indicates that the occurrence of howling is detected, the howling determination unit 27 outputs an instruction to adjust the first gain and the second gain to the gain adjustment units 28 and 29.

When the determination result from the howling determination unit 27 indicates that the occurrence of howling is detected, the gain adjustment unit 28 adjusts the first gain by which the microphone signal is multiplied to reduce the power (a level) of the microphone signal to be lower than a current value (for example, an initial value) stored in the memory 11 based on the instruction from the howling determination unit 27 and the number of detection times of howling stored in the memory 11. The gain adjustment unit 28 outputs an adjusted first gain to the variable amplifier VG1. A reduction amount of the first gain from the current value is set in advance (for example, is stored in the memory 11). The gain adjustment unit 28 may include an adaptive notch filter NF1. The adaptive notch filter NF1 adjusts and sets a notch reduction gain (that is, a gain for reducing the microphone signal) based on the determination result of the howling determination unit 27, and outputs the set notch reduction gain (an example of the first gain described above) to the variable amplifier VG1. When the gain adjustment unit 28 receives a determination result indicating that howling is not detected from the howling determination unit 27 after the first gain is adjusted, the gain adjustment unit 28 may gradually or return the adjusted first gain to an original value or return the adjusted first gain to the original value at once.

When the determination result from the howling determination unit 27 indicates that the occurrence of howling is detected, the gain adjustment unit 29 adjusts the second gain by which the speaker signal is multiplied to reduce the power (a level) of the speaker signal to be lower than a current value (for example, an initial value) stored in the memory 11 based on the instruction from the howling determination unit 27 and the number of detection times of howling stored in the memory 11. The gain adjustment unit 29 outputs an adjusted second gain to the variable amplifier VG2. A reduction amount of the second gain from the current value is set in advance (for example, is stored in the memory 11), and may be larger, smaller, or the same as the above-described reduction amount of the first gain from the current value. The gain adjustment unit 29 may include an adaptive notch filter NF2. The adaptive notch filter NF2 adjusts and sets a notch reduction gain (that is, a gain for reducing the speaker signal) based on the determination result of the howling determination unit 27, and outputs the set notch reduction gain (an example of the second gain described above) to the variable amplifier VG2. When the gain adjustment unit 29 receives a determination result indicating that howling is not detected from the howling determination unit 27 after the second gain is adjusted, the gain adjustment unit 29 may gradually return the adjusted second gain to an original value or return the adjusted second gain to the original value at once.

The variable amplifier VG1 is arranged such that the microphone signal from the microphone Midi is input to the variable amplifier VG1 before the microphone signal is input to the web conference application 142. and amplifies or weakens the microphone signal using the first gain instructed by the howling detector HWD. For example, the variable amplifier VG1 amplifies or weakens the microphone signal based on the adjusted first gain from the gain adjustment unit 28. Therefore, when the first gain is reduced due to the adjustment executed by the gain adjustment unit 28, the microphone signal is weakened by the variable amplifier VG1.

The variable amplifier VG2 is arranged such that the speaker signal processed by the web conference application 142 is input to the variable amplifier VG2 before the speaker signal is input to the speaker SPK1, and amplifies or weakens the speaker signal using the second gain instructed by the howling detector HWD. For example, the variable amplifier VG2 amplifies or weakens the speaker signal based on the adjusted second gain from the gain adjustment unit 29. Therefore, when the second gain is reduced due to the adjustment executed by the gain adjustment unit 29, the speaker signal is weakened by the variable amplifier VG2.

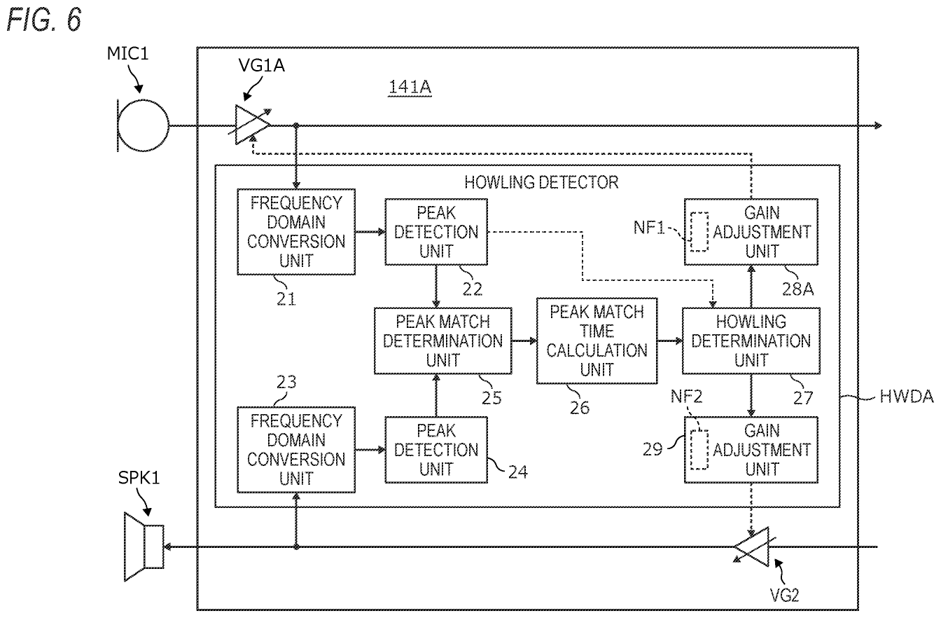

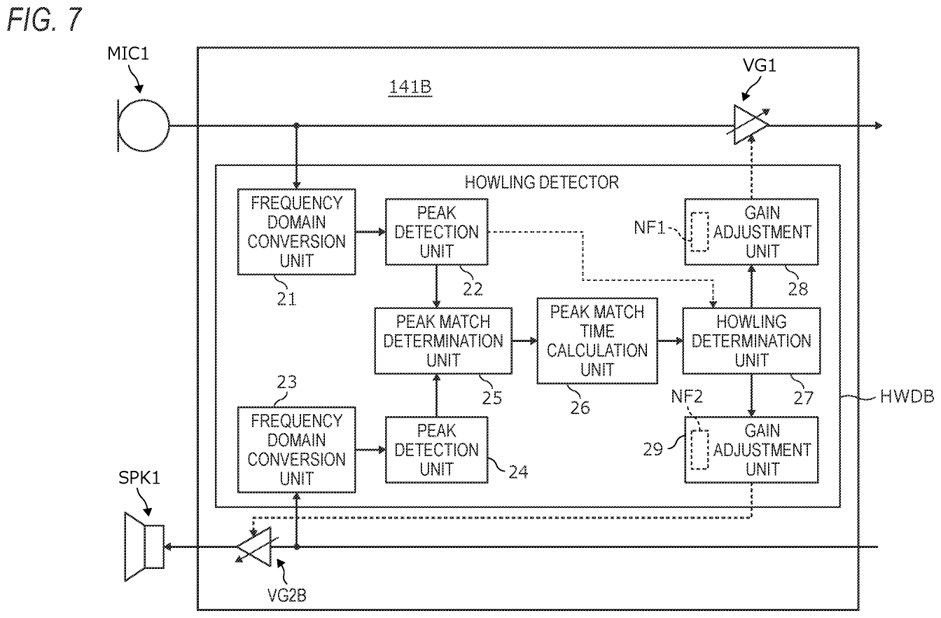

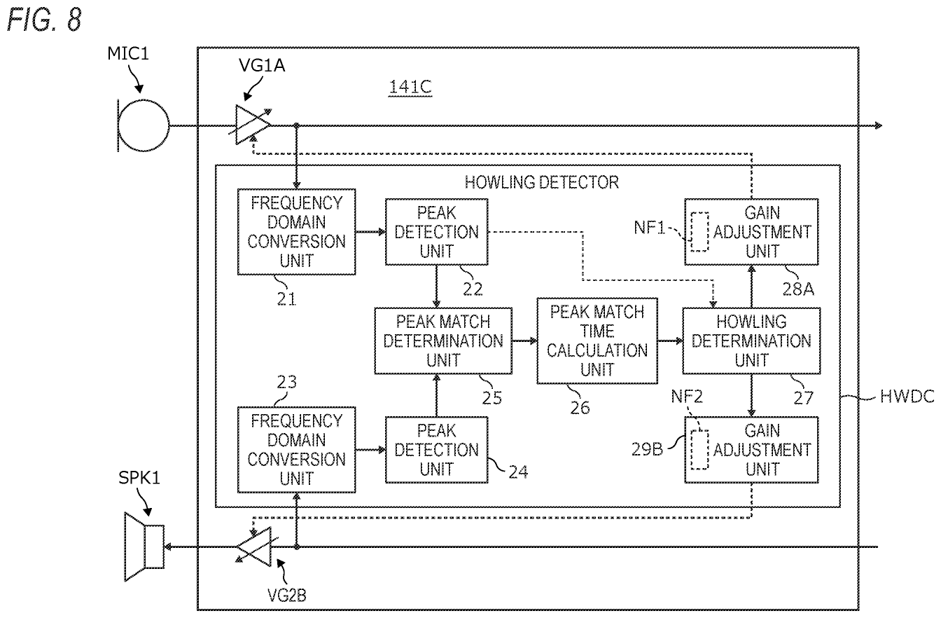

The configuration of the voice signal processing unit of the processor 14 is not limited to the configuration of the voice signal processing unit 141 shown in FIG. 5, and may be voice signal processing units 141A, 141B, and 141C shown in FIGS. 6 to 8. FIG. 6 is a block diagram showing a second configuration example of the voice signal processing unit. FIG. 7 is a block diagram showing a third configuration example of the voice signal processing unit. FIG. 8 is a block diagram showing a fourth configuration example of the voice signal processing unit. In description of FIGS. 6 to 8, the same elements as those of the voice signal processing unit 141 shown in FIG. 4 are denoted by the same reference numerals, description thereof will be simplified or omitted, and different contents will be described.

Similarly to the voice signal processing unit 141 shown in FIG. 4, a voice signal processing unit 141A shown in FIG. 6 includes at least a howling detector HWDA and variable amplifiers VG1A and VG2. The howling detector HWDA includes the frequency domain conversion unit 21, the peak detection unit 22, the frequency domain conversion unit 23, the peak detection unit 24, the peak match determination unit 25, the peak match time calculation unit 26, the howling determination unit 27, and gain adjustment units 28A and 29.

In the configuration example of the voice signal processing unit 141A shown in FIG. 6, the microphone signal from the microphone MIC1 after the microphone signal is amplified or reduced by the variable amplifier VG1 A is input to the frequency domain conversion unit 21.

When the determination result from the howling determination unit 27 indicates that the occurrence of howling is detected, the gain adjustment unit 28A adjusts the first gain by which the microphone signal is multiplied to reduce the power (a level) of the microphone signal to be lower than a current value (for example, an initial value) stored in the memory 11 based on the instruction from the howling determination unit 27 and the number of detection times of howling stored in the memory 11. The gain adjustment unit 28A outputs the adjusted first gain to the variable amplifier VG1A. The gain adjustment unit 28A may include the adaptive notch filter NF1. The adaptive notch filter NF1 adjusts and sets a notch reduction gain (that is, a gain for reducing the microphone signal) based on the determination result of the howling determination unit 27, and outputs the set notch reduction gain (an example of the first gain described above) to the variable amplifier VG1A.

The variable amplifier VG1A is arranged such that the microphone signal from the microphone MIC1 is input to the variable amplifier VG1A before the microphone signal is input to the frequency domain conversion unit 21 and the web conference application 142. The variable amplifier VG1A amplifies or weakens the microphone signal using the first gain instructed by the howling detector HWDA. For example, the variable amplifier VG1A amplifies or weakens the microphone signal based on the adjusted first gain from the gain adjustment unit 28A. Therefore, when the first gain is reduced due to the adjustment executed by the gain adjustment unit 28A, the microphone signal is weakened by the variable amplifier VG1A and is input to the web conference application 142.

Similar to the voice signal processing unit 141 shown in FIG. 4, a voice signal processing unit 141B shown in FIG. 7 includes at least a howling detector I-IWDB and variable amplifiers VG1A and VG2B. The howling detector HWDB includes the frequency domain conversion unit 21, the peak detection unit 22, the frequency domain conversion unit 23, the peak detection unit 24, the peak match determination unit 25, the peak match time calculation unit 26, the howling determination unit 27, and gain adjustment units 28 and 29B.

In the configuration example of the voice signal processing unit 141B shown in FIG. 7, the speaker signal before being amplified or weakened by the variable amplifier VG2B is input to the frequency domain conversion unit 23.

When the determination result from the howling determination unit 27 indicates that the occurrence of howling is detected, the gain adjustment unit 29B adjusts the second gain by which the speaker signal is multiplied to reduce the power (a level) of the speaker signal to be lower than a current value (for example, an initial value) stored in the memory 11 based on the instruction from the howling determination unit 27 and the number of detection times of howling stored in the memory 11. The gain adjustment unit 29B outputs the adjusted second gain to the variable amplifier VG2B. The gain adjustment unit 29B may include the adaptive notch filter NF2. The adaptive notch filter NF2 adjusts and sets a notch reduction gain (that is, a gain for reducing the speaker signal) based on the determination result of the howling determination unit 27, and outputs the set notch reduction gain (an example of the second gain described above) to the variable amplifier VG2B.

The variable amplifier VG2B is arranged at a stage preceding the speaker SPK1 such that the speaker signal is input to the variable amplifier VG2B after the speaker signal is input to the frequency domain conversion unit 23. The variable amplifier VG2B amplifies or weakens the speaker signal using the second gain instructed from the howling detector HWDB. For example, the variable amplifier VG2B amplifies or weakens the speaker signal based on the adjusted second gain from the gain adjustment unit 29B. Therefore, when the second gain is reduced due to the adjustment executed by the gain adjustment unit 29B, the speaker signal is weakened by the variable amplifier VG2B and input to the speaker SPK1.

Similar to the voice signal processing unit 141 shown in FIG. 4, the voice signal processing unit 141C shown in FIG. 8 includes at least a howling detector HWDC and the variable amplifiers VG1A and VG2B. The howling detector HWDC includes the frequency domain conversion unit 21, the peak detection unit 22, the frequency domain conversion unit 23, the peak detection unit 24, the peak match determination unit 25, the peak match time calculation unit 26, the howling determination unit 27, and the gain adjustment units 28A and 29B.

In the configuration. example of the voice signal processing unit 141C shown in FIG. 8, the microphone signal from the microphone MIC1 after being amplified or weakened by the variable amplifier VG1A is input to the frequency domain conversion unit 21, and the speaker signal before being amplified or weakened by the variable amplifier VG2B is input to the frequency domain converting unit 23.

When the determination result from the howling determination unit 27 indicates that the occurrence of howling is detected, the gain adjustment unit 28A adjusts the first gain by which the microphone signal is multiplied to reduce the power (a level) of the microphone signal to be lower than a current value (for example, an initial value) stored in the memory 11 based on the instruction from the howling determination unit 27 and the number of detection times of howling stored in the memory 11. The gain adjustment unit 28A outputs the adjusted first gain to the variable amplifier VG1A. The gain adjustment unit 28A may include the adaptive notch filter NF1 The adaptive notch filter NF1 adjusts and sets a notch reduction gain (that is, a gain fix reducing the microphone signal) based on the determination result of the howling determination unit 27, and outputs the set notch reduction gain (an example of the first gain described above) to the variable amplifier VG1A.

The variable amplifier VG1A is arranged such that the microphone signal from the microphone MIC1 is input to the variable amplifier VG1A before the microphone signal is input to the frequency domain conversion unit 21 and the web conference application 142. The variable amplifier VG1A amplifies or weakens the microphone signal using the first gain instructed by the howling detector HWDC. For example, the variable amplifier VG1A amplifies or weakens the microphone signal based on the adjusted first gain from the gain adjustment unit 28A. Therefore, when the first gain is reduced due to the adjustment executed by the gain adjustment unit 28A, the microphone signal is weakened by the variable amplifier VG1A and is input to the web conference application 142.

When the determination result from the howling determination unit 27 indicates that the occurrence of howling is detected, the gain adjustment unit 29B adjusts the second gain by which the speaker signal is multiplied to reduce the power (a level) of the speaker signal to be lower than a current value (for example, an initial value) stored in the memory 11 based on the instruction from the howling determination unit 27 and the number of detection times of howling stored in the memory 11. The gain adjustment unit 29B outputs the adjusted second gain to the variable amplifier VG2B. The gain adjustment unit 29B may include the adaptive notch filter NF2. The adaptive notch filter NF2 adjusts and sets a notch reduction gain (that is, a gain for reducing the speaker signal) based on the determination result of the howling determination unit 27, and outputs the set notch reduction gain (an example of the second gain described above) to the variable amplifier VG2B.

The variable amplifier VG2B is arranged at a stage preceding the speaker SPK1 such that the speaker signal is input to the variable amplifier VG2B after the speaker signal is input to the frequency domain conversion unit 23. The variable amplifier VG2B amplifies or weakens the speaker signal using the second gain instructed by the howling detector HWDC. For example, the variable amplifier VG2B amplifies or weakens the speaker signal based on the adjusted second gain from the gain adjustment unit 29B. Therefore, when the second gain is reduced due to the adjustment executed by the gain adjustment unit 29B, the speaker signal is weakened by the variable amplifier VG2B and input to the speaker SPK1.

Next, an overall operation procedure of the PC 10 according to the first embodiment will be described with reference to FIG. 9. FIG. 9 is a flowchart showing an example of an overall operation procedure of the PC 10 according to the first embodiment. Each processing shown in FIG. 9 is mainly executed by the processor 14 of the PC 10.

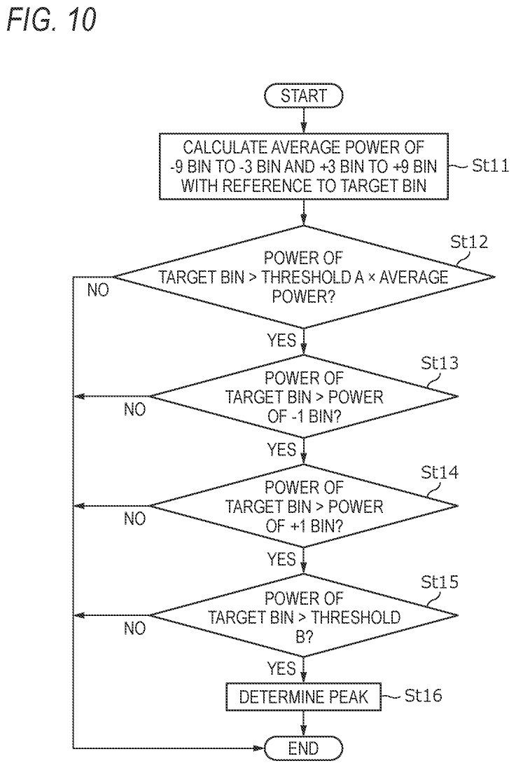

In FIG. 9, the processor 14 converts a microphone signal in a time domain into a microphone signal in a frequency domain by executing a Fourier transform on the microphone signal from the microphone MIC1 (St1). The microphone signal in the frequency domain may be, for example, a signal from 100 Hz to 2500 Hz. The processor 14 detects a first peak frequency at which the power of the microphone signal Mc1 obtained for each bin of the microphone signal Mc1 has a maximum value based on frequency characteristics of a microphone signal (for example, the microphone signal Mc1 shown in FIG. 5) in a frequency domain obtained by the conversion in step St1 (St2). Here, the bin indicates a frequency band (for example, a 10 Hz band) in a minute predetermined range. Therefore, in step St2, the processor 14 detects a first peak frequency at which the power of the microphone signal Mc1 is at the peak (has a maximum value) for each bin of 2400 Hz from 100 Hz to 2500 Hz (that is, a total of 240 bins when one bin is formed for every 10 Hz band). Details of step St2 will be described later with reference to FIG. 10.

The processor 14 converts a speaker signal in a time domain into the speaker signal Sp1 in a frequency domain by executing a Fourier transform on the speaker signal before the speaker signal is input to the speaker SPK1 (St3). The frequency domain is, for example, 100 Hz to 2500 Hz. The processor 14 detects a second peak frequency at which the power of the speaker signal Sp1 obtained for each bin of the speaker signal Sp1 has a maximum value based on frequency characteristics of the speaker signal (for example, the speaker signal Sp1 shown in FIG. 5) in the frequency domain obtained by the conversion in step St3 (St4). Therefore, in step St4, the processor 14 detects, for example, the second peak frequency at Which the power of the speaker signal Sp1 is at the peak (has a maximum value) for each bin of 2400 Hz from 100 Hz to 2500 Hz (that is, a total of 240 bins when one bin is formed for every 10 Hz band). Details of step St4 will be described later with reference to FIG. 10.

Based on the detection results of steps St2 and St4, the processor 14 determines whether the first peak frequency (for example, f1 and f2 shown in FIG. 5) detected in step St2 and the second peak frequency (for example, f3 and f4 shown in FIG. 5) detected in step St4 match each other, and whether a time during which the peaks match each other continues for a predetermined time (for example, 100 milliseconds) or more (St5). When the first peak frequency and the second peak frequency does not match each other and the time during which the peaks match each other is not continuous for the predetermined time (for example, 100 milliseconds) or more (St5, NO), howling does not occur, and thus the processing of the processor 14 shown in FIG. 9 is ended.

On the other hand, when the processor 14 determines that the first peak frequency and the second peak frequency match each other and the time during which the peak matching continues for a predetermined time (for example, 100 milliseconds) or more (St5, YES), the processor 14 determines that howling occurs, increments the number of detection times of howling, and stores the number of detection times of howling in the memory 11 (St6).

When the processor 14 detects howling, the processor 14 adjusts the first gain by which the microphone signal is multiplied in order to reduce the power (a level) of the microphone signal before the microphone signal is input to the web conference application 142 to be lower than a current value (St7), and adjusts the second gain by which the speaker signal is multiplied in order to reduce the power (a level) of the speaker signal before the speaker signal is input to the speaker SPK1 to be lower than a current value (St7).

The processor 14 reduces the power (the level) of the microphone signal before the microphone signal is input to the web conference application 142 by using the first gain adjusted in step St7 (St8). The processor 14 reduces the power (the level) of the speaker signal before the speaker signal is input to the speaker SPK1 by using the second gain adjusted in step St7 (St9). Based on the occurrence of the howling in step St6, the processor 14 displays, on the display device 16, the display screen MSG1a (see FIG. 3) for notifying the occurrence of the howling or the display screen MSG1b (see FIG. 3) for notifying that a volume of a voice signal output from the speaker SPK1 is reduced (St10).

Next, an operation procedure of detecting the first peak frequency and the second peak frequency by the PC 10 according to the first embodiment will be described with reference to FIG. 10. FIG. 10 is a flowchart showing an operation procedure example of a peak determination processing as a subroutine. Each processing shown in FIG. 10 is mainly executed by the processor 14 of the PC 10. An operation procedure of detecting the first peak frequency will be described as an example, and can be similarly applied to the operation procedure of detecting the second peak frequency.

in FIG. 10, the processor 14 sequentially scans target bins (that is, a bin in which average power of a microphone signal is to be calculated) of, for example, 100 Hz to 2500 Hz, and executes processings in the following steps St11 to St16 for each target bin. Specifically, with reference to the target bin, the processor 14 calculates, for example, average power in a frequency domain of the microphone signal in each range of a range from a frequency band of −9 bins from the target bin (that is, a frequency band reduced by 9 bins from the target bin) to a frequency band of −3 bins from the target bin (that is, a frequency band reduced by 3 bins from the target bin) and a range from a frequency band of +3 bins from the target bin (that is, a frequency band increased by 3 bins from the target bin) to a frequency band of +9 bins from the target bin (that is, a frequency band increased by 9 bins from the target bin) (St11).

The processor 14 determines whether a power in a frequency domain of the microphone signal of the target bin is larger than a multiplication result of the average power calculated in step St11 and the threshold A read from the memory 11 (St12). When it is determined that the power in the frequency domain of the microphone signal of the target bin is smaller than the multiplication result of the average power calculated in step St11 and the threshold value A read from the memory 11 (St12, NO), the processor 14 determines that the power of the target bin is not a peak, and the processor 14 ends the processing shown in FIG. 10.

On the other hand, when the processor 14 determines that the power in the frequency domain of the microphone signal of the target bin is larger than the multiplication result of the average power calculated in step St11 and the threshold value A read from the memory 11 (St12, YES), the processor 14 determines whether the power in the frequency domain of the microphone signal of the target bin is larger than power in a frequency band of −1 bin from the target bin (that is, a frequency band reduced by 1 bin from the target bin) (St13). When it is determined that the power in the frequency domain of the microphone signal of the target bin is smaller than the power in the frequency band of −1 bin from the target bin (that is, a frequency band reduced by 1 bin from the target bin) (St13 NO). the processor 14 determines that the power of the target bin is not a peak, and the processor 14 ends the processing shown in FIG. 10.

On the other hand, when it is determined that the power in the frequency domain of the microphone signal of the target bin is larger than the power in the frequency band of −1 bin from the target bin (that is, a frequency band reduced by 1 bin from the target bin) (St13, YES), the processor 14 determines whether the power in the frequency domain of the microphone signal of the target bin is larger than power in a frequency band of +1 bin from the target bin (that is, a frequency band increased by 1 bin from the target bin) (St14). When it is determined that the power in the frequency domain of the microphone signal of the target bin is smaller than the power in the frequency band of +1 bin from the target bin (that is, a frequency band increased by 1 bin from the target bin) (St14, NO), the processor 14 determines that the power of the target bin is not a peak, and the processor 14 ends the processing shown in FIG. 10.

On the other hand, when the processor 14 determines that the power in the frequency domain of the microphone signal of the target bin is larger than the power in the frequency band of +1 bin from the target bin (that is, a frequency band increased by one bin from the target bin) (St14, YES), the processor 14 determines whether the power in the frequency domain of the microphone signal of the target bin is larger than the threshold value B read from the memory 11 (St15). When it is determined that the power in the frequency domain of the microphone signal of the target bin is smaller than the threshold value B read from the memory 11 (St15, NO), the processor 14 determines that the power of the target bin is not a peak, and the processor 14 ends the processing shown in FIG. 10.

On the other hand, when the processor 14 determines that the power in the frequency domain of the microphone signal of the target bin is larger than the threshold value B read from the memory 11 (St15, YES), the processor 14 determines that the power in the frequency domain of the microphone signal of the target bin is a peak (St16). After step St16, the processor 14 ends the processing shown in FIG. 10.

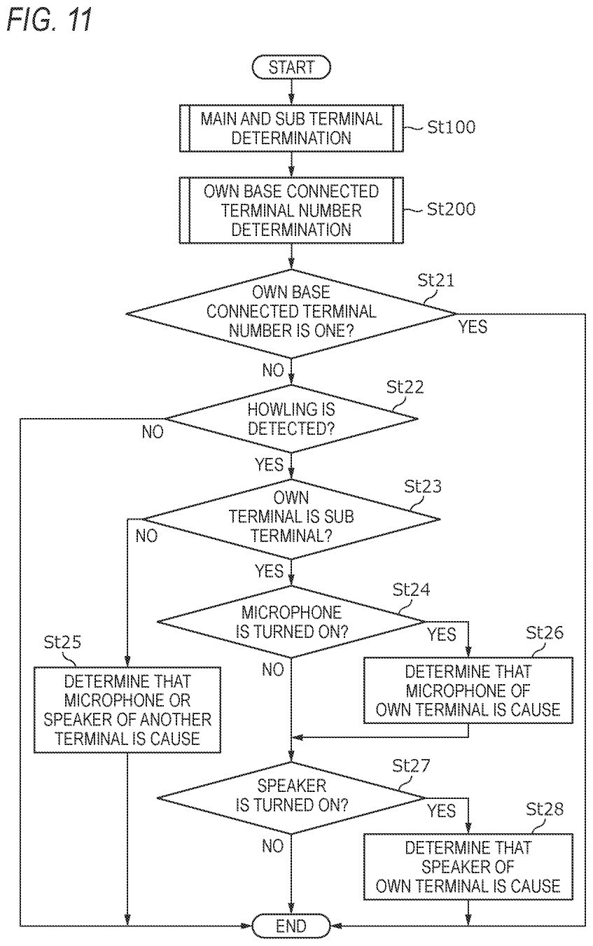

Next, a howling cause determination processing executed by the PC 10 when the PC 10 does not transmit the own terminal status information and the other terminal status information to or receive the own terminal status information and the other terminal status information from (that is, the PC 10 is not linked with the PC 20) the PC 20 arranged in the own base (here, the base B1 where the PC 10 is arranged) will be described with reference to FIG. 11. FIG. 11 is a flowchart showing an example of a howling cause determination procedure when the PC 10 according to the first embodiment is not linked with another terminal. Since the howling cause determination procedure shown in FIG. 11 is the same as a howling cause determination processing executed by the PCs 20 and 30, description thereof will be omitted.

The main and sub determination unit 143B determines whether an own terminal (here, the PC 10) is a main terminal or a sub terminal (St100). A main and sub determination processing will be described later with reference to FIGS. 16 to 24.

The own base connected terminal number determination unit 143C determines whether the number of PCs connected to a venue (an address) of a web conference provided by the web conference system 100 from the main base (here, the same base as the base in which the PC 10 is arranged) is one (that is, whether the connected PC is only an own terminal (the PC 10)) (St200). The main and sub determination processing will be described later with reference to FIGS. 25 to 27.

The cause determination unit 143 determines whether the number of connected PCs in the own base is one (that is, whether the connected PC is only the own terminal (the PC 10)) based on a processing result of step St200 (St21).

When it is determined in the processing of step St21 that the number of connected PCs in the own base is one (S121, YES), the cause determination unit 143 ends the howling cause determining processing shown in FIG. 11. On the other hand, when it is determined in the processing of step St21 that the number of connected PCs in the own base is not one (St21, NO), the cause determination unit 143 determines whether howling is detected by the howling detector HWD (St22).

When it is determined in the processing of step St22 that howling is detected (St22, YES), the cause determination unit 143 determines whether the own terminal (the PC 10) is set as a sub terminal (St23). On the other hand, when it is determined in the processing of step St22 that no howling is detected (St22, NO), the cause determination unit 143 ends the howling cause determination processing shown in FIG. 11.

When it is determined in the processing of step St23 that the own terminal (the PC 10) is set as a sub terminal (St23, YES), the cause determination unit 143 determines whether the microphone MIC1 provided in the PC 10 is turned on (St24). On the other hand, when it is determined in the processing of step St23 that the own terminal (the PC 10) is not set as a sub terminal (that is, the own terminal is set as a main terminal) (St23, NO), the cause determination unit 143 determines that a microphone or a speaker provided in another terminal (here, the PC 20) is the howling cause (St25), and ends the howling cause determination processing shown in FIG. 11.

When it is determined in the processing of step St24 that the microphone MIC1 provided in the PC 10 is turned on (St24, YES), the cause determination unit 143 determines that the microphone MIC1 of the own terminal (the PC 10) is the howling cause (St26). On the other hand, when it is determined in the processing of step St24 that the microphone MIC1 provided in the PC 10 is not turned on (St24, NO), the cause determination unit 143 determines whether the speaker SPK1 of the own terminal (the PC 10) is turned on after executing the processing of step St26 (St27).

When it is determined in the processing of step St27 that the speaker SPK1 provided in the PC 10 is turned on (St27, YES), the cause determination unit 143 determines that the speaker SPK1 of the own terminal (the PC 10) is the howling cause (St28). On the other hand, when it is determined in the processing of step St27 that the speaker SPK1 provided in the PC 10 is not turned on (St27, NO), the cause determination unit 143 ends the howling cause determining processing shown in FIG. 11 after executing the processing of step St28.

As described above, the PC 10 Which is an example of the voice communication apparatus according to the first embodiment can determine a howling cause even when the PC 10 is not linked with another terminal (the PC 20). In addition, the PC 10 can present a howling cause to a user by displaying the determined howling cause on the display device 16.

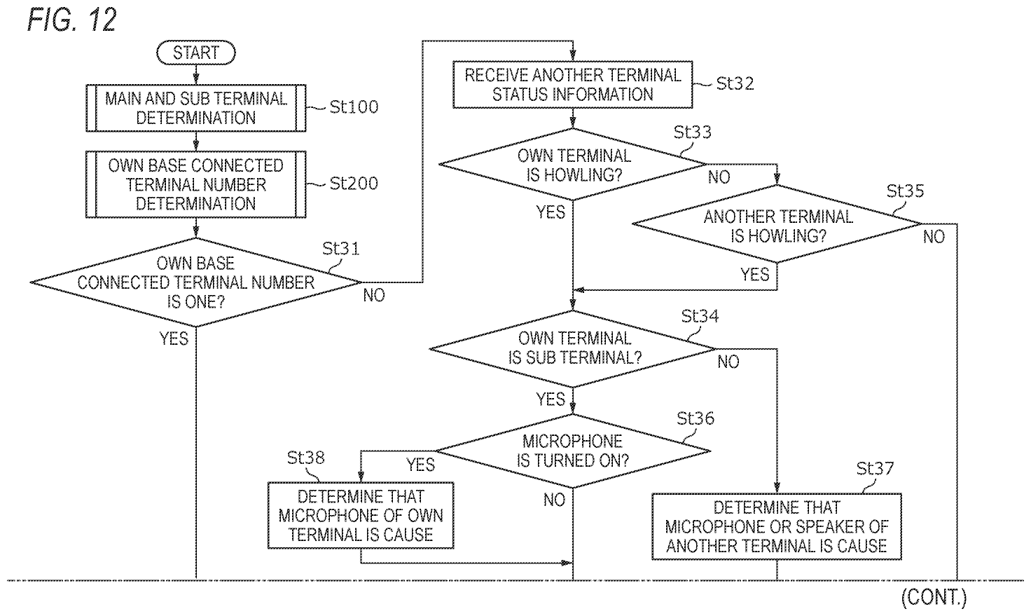

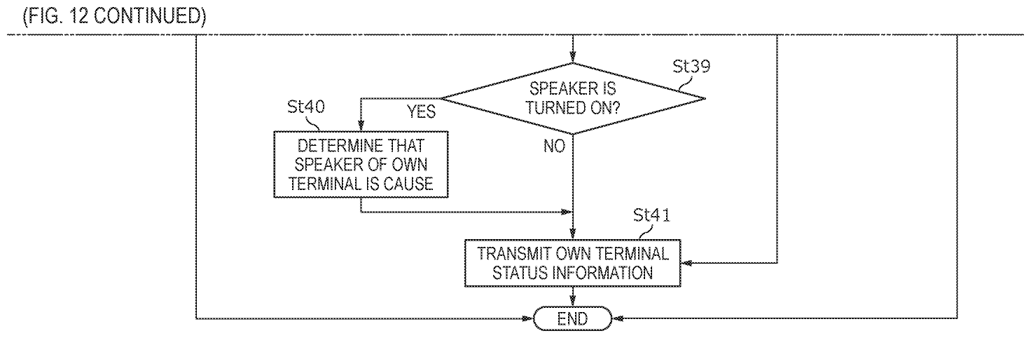

Next, a howling cause determination processing executed by the PC 10 when the PC 10 transmits the own terminal status information and the other terminal status information to or receives the own terminal status information and the other terminal status information from (that is, the PC 10 is linked with the PC 20) the PC 20 arranged in the own base (here, the base B1 where the PC 10 is arranged) will be described with reference to FIG. 12. FIG. 12 is a flowchart showing an example of a howling cause determination procedure when the PC 10 according to the first embodiment is linked with another terminal. Since the howling cause determination procedure shown in FIG. 12 is the same as the howling cause determination processing executed by the PCs 20 and 30, description thereof will be omitted.

The main and sub determination unit 143B determines whether an own terminal (here, the PC 10) is a main terminal or a sub terminal (St100). A main and sub determination processing will be described later with reference to FIGS. 16 to 24.

The own base connected terminal number determination unit 1430 determines whether the number of PCs connected to a venue (an address) of a web conference provided by the web conference system 100 from the main base (here, the same base as the base in which the PC 10 is arranged) is one (that is, whether the connected PC is only the own terminal (the PC 10)) (St200). The main and sub determination processing will be described later with reference to FIGS. 25 to 27.

The cause determination unit 143 determines whether the number of connected PCs in the own base is one (that is, whether the connected PC is only the own terminal (the PC 10)) based on a processing result of step St200 (St31).

When it is determined in the processing of step S31 that the number of connected PCs in the own base is one (St31, YES), the cause determination unit 143 ends the howling cause determining processing shown in FIG. 12. On the other hand, when it is determined in the processing of step St31 that the number of connected. PCs in the own base is not one (St31, NO), the cause determination unit 143 acquires the other terminal status information of another terminal (here, the PC 20) received by the communication interface 15 (St32). The processing of step St32 may be executed periodically (for example, every several minutes) without depending on the operation procedure, and may be capable of acquiring a status change of each PC during a web conference. The cause determination unit 143 determines whether howling is detected by the howling detector HWD (St33).

When it is determined in the processing of step St33 that howling is detected (St33. YES), the cause determination unit 143 determines whether the own terminal (the PC 10) is set as a sub terminal (St34). On the other hand, when it is determined in the processing of step St13 that no howling is detected (St33, NO), the cause determination unit 143 determines whether howling occurs in the other terminal based on the acquired another terminal status information (St35).

When it is determined in the processing of step St34 that the own terminal (the PC 10) is set as a sub terminal (St34, YES), the cause determination unit 143 determines Whether the microphone MIC1 provided in the PC 10 is turned on (St36). On the other hand, when it is determined in the processing of step St34 that the own terminal (the PC 10) is not set as a sub terminal (that is, the own terminal is set as a main terminal) (St34, NO), the cause determination unit 143 determines that a microphone or a speaker provided in the other terminal (here, the PC 20) is the howling cause (St37), generates own terminal status information, and outputs the own terminal status information to the communication interface 15. The communication interface 15 transmits the own terminal status information output from the cause determination unit 143 to the other terminal (the PC 20) (St41).

When it is determined in the processing of step St35 that howling occurs in the other terminal (the PC 20) (St35, YES), the cause determination unit 143 determines Whether the own terminal (the PC 10) is set as a sub terminal (St34). On the other hand, when it is determined in the processing of step St35 that no howling occurs in the other terminal (the PC 20) (St35, NO). the cause determination unit 143 ends the howling cause determining processing shown in FIG. 12.

When it is determined in the processing of step St36 that the microphone MIC1 provided in the PC 10 is turned on (St36, YES), the cause determination unit 143 determines that the microphone MIC1 of the own terminal (the PC 10) is the howling cause (St38). On the other hand, when it is determined in the processing of step St36 that the microphone MIC1 provided in the PC 10 is not turned on (St36, NO), the cause determination unit 143 determines whether the speaker SPK1 of the own terminal (the PC 10) is turned on after the processing of step St38 (St39).

When it is determined in the processing of step St39 that the speaker SPK1 provided in the PC 10 is turned on (St39, YES), the cause determination unit 143 determines that the speaker SPK1 of the own terminal (the PC 10) is the howling cause (St40). On the other hand, when it is determined in the processing of step St39 that the speaker SPK1 provided in the PC 10 is not turned on (St39, NO), the cause determination unit 143 generates own terminal status information and outputs the own terminal status information to the communication interface 15 after executing the processing of step St40. The communication interface 15 transmits the own terminal status information output from the cause determination unit 143 to the other terminal (the PC 20) (St41).

As described above, when the PC 10 which is an example of the voice communication apparatus according to the first embodiment is linked with another terminal (the PC 20), the PC 10 can determine whether a howling cause is the own terminal (the PC 10) or the other terminal (the PC 20) based on the other terminal status information transmitted from the other terminal (the PC 20 in this case). When the PC 10 determines that howling is detected in the own terminal (the PC 10), the PC 10 determines a howling cause and displays the determined howling cause on the display device 16, thereby presenting the howling cause to a user

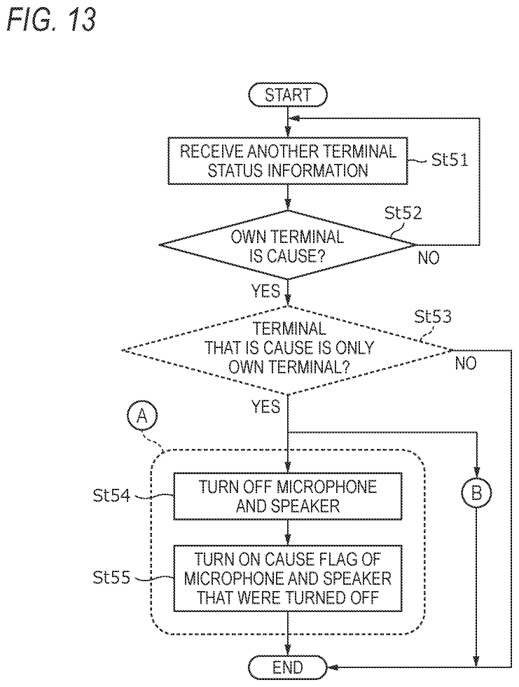

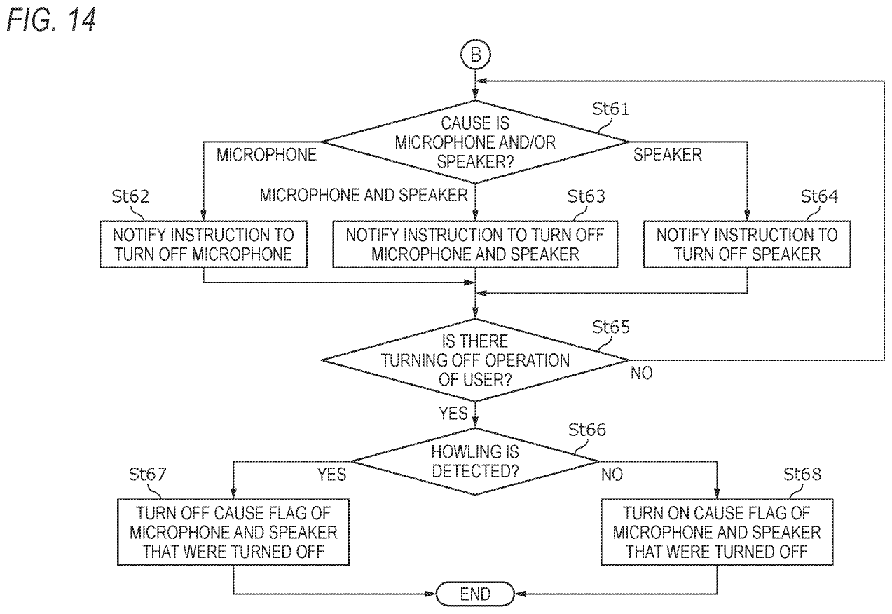

The cause flag determination procedure executed by the PC 10 after the howling cause determination will be described with reference to FIGS. 13 and 14. FIG. 13 is a flowchart showing an example of a cause flag determination procedure of the PC 10 according to the first embodiment. FIG. 14 is a flowchart showing an example of a cause flag determination procedure of the PC 10 according to the first embodiment.

The cause flag determination procedure shown in FIGS. 13 and 14 is executed after the howling cause determination procedure shown in FIG. 12. The cause flag determination procedure shown in FIGS. 13 and 14 is executed in the same manner as in the PCs 20 and 30, and thus description thereof is omitted here.

The communication interface 15 acquires the other terminal status information transmitted from another terminal (here, the PC 20) connected to the own base, and outputs the other terminal status information to the cause determination unit 143. The cause determination unit 143 acquires the other terminal status information of the other terminal output from the communication interface 15 (St51).

The cause determination unit 143 determines whether a howling cause is the own terminal (here, the PC 10) based on the acquired another terminal status information of the other terminal (St52).

When it is determined in the processing of step St52 that the howling cause is the own terminal (the PC 10) (St52, YES), the cause determination unit 143 determines whether the terminal (PC) that is the howling cause is only the own terminal (the PC 10) (St53). On the other hand, when it is determined in the processing of step St52 that the howling cause is not the own terminal (the PC 10) (St52, NO), the cause determination unit 143 returns the processing to the processing of step St51.

When it is determined in the processing of step St53 that the terminal (PC) that is the cause is only the own terminal (the PC 10) (St53, YES), the cause determination unit 143 proceeds to the processing of at least one of step St54 and step St61. The processings of steps St54 to St55 and the processings of steps St61 to St68 may be executed in parallel.

For example, in a case where it is determined that the howling cause is the own terminal (the PC 10), when setting for turning off (muting) a device (that is, the microphone MIC1 and the speaker SPK1) that may become a howling cause is set in advance, the PC 10 executes the processings of steps St54 to St55, or executes the processings of steps St54 to St55 and the processings of steps St61 to St68 in parallel.

For example, in a case where it is determined that the howling cause is the own terminal (the PC 10), when setting for turning off (muting) a device (that is, the microphone MIC1 and the speaker SPK1) that may become a howling cause is not set in advance, the PC 10 executes the processings of step St61 to step St68 and notifies (presents) a user of the device (that is, the microphone MIC1 and the speaker SPK1) that is determined to be the howling cause, so that a user operation can tum off the device (the microphone MIC1 and the speaker SPK1). As a result, the PC 10 can ensure a degree of freedom related to the setting of each of the microphone MIC1 and the speaker SPK1 in the web conference.

When the cause determination unit 143 proceeds the processing to the processing of step St54, the cause determination unit 143 turns off the microphone MIC1 and the speaker SPK1 (St54), and turns on cause flags of the microphone MIC1 and the speaker SPK1 that were turned off (St55).

On the other hand, after the cause determination unit 143 proceeds the processing to the processing of step St61, the cause determination unit 143 determines whether a howling cause is the microphone MIC1, the speaker SPK1, or both the microphone MIC1 and the speaker SPK1 of the PC 10 (St61).

When it is determined in the processing of step St61 that the howling cause is the microphone MIC1 (St61, microphone), the cause determination unit 143 generates a determination result of the howling cause and outputs the determination result to the alert notification unit 144. The alert notification unit 144 generates the alert screen MSG2b for presenting a user operation instruction to turn off the microphone MIC1 to a user based on the determination result of the howling cause output from the cause determination unit 143, and outputs the alert screen MSG2b to and displays the alert screen MSG2b on the display device 16 (St62). As a result, the PC 10 can present to a user that the microphone MIC1 is a howling cause, and can notify the user of an instruction to turn off the microphone MIC1 as an operation for eliminating the howling cause.

When it is determined in the processing of step St61 that the howling cause is both the microphone MIC1 and the speaker SPK1 (St61, microphone, speaker), the cause determination unit 143 generates a determination result of the howling cause and outputs the determination result to the alert notification unit 144. The alert notification unit 144 generates the alert screen MSG2b for presenting a user operation instruction to turn off the microphone MIC1 and the speaker SPK1 to a user based on the determination result of the howling cause output from the cause determination unit 143, and outputs the alert screen MSG2b to and displays the alert screen MSG2b on the display device 16 (St63). As a result, the PC 10 can present to a user that both the microphone MIC1 and the speaker SPK1 are a howling cause, and can notify the user of an instruction to turn off the microphone MIC1 and the speaker SPK1 as an operation for eliminating the howling cause.

When it is determined in the processing of step St61 that the howling cause is the speaker SPK1 (St61, speaker), the cause determination unit 143 generates a determination result of the howling cause and outputs the determination result to the alert notification unit 144. The alert notification unit 144 generates the alert screen MSG2b for presenting a user operation instruction to turn off the speaker SPK1 to a user based on the determination result of the howling cause output from the cause determination unit 143, and outputs the alert screen MSG2b to and displays the alert screen MSG2b on the display device 16 (St64). As a result, the PC 10 can present to a user that the speaker SPK1 is a howling cause, and can notify the user of an instruction to turn off the speaker SPK1 as an operation for eliminating the howling cause.

After the alert screen MSG2b is displayed on the display device 16 by the alert notification unit 144, the processor 14 determines whether there is a user operation for turning off the device (that is, the microphone MIC1 and the speaker SPK1) which is the howling cause (St65). Specifically, the processor 14 determines whether there is a mute operation for the device (the microphone MIC1 or the speaker SPK1) that was determined to be the howling cause by a user operation based on a control command output from the operation device 12

When it is determined in the processing of step St65 that there is a user operation for turning off the device which is the howling cause (St65, YES), the processor 14 causes the howling detector HWD to execute the howling detection processing again after a predetermined time (for example, several seconds) from a timing when the user operation is performed (St66). On the other hand, when it is determined in the processing of step St65 that there is no user operation for turning off the device which is the howling cause (St65, NO), the processor 14 returns the processing to the processing of step St61.

When it is determined that howling is detected in the processing of step St66 (St66, YES), the howling detector HWD outputs a howling detection result to the cause flag determination unit 144A. Based on the howling detection result, the cause flag determination unit 144A sets a cause flag of the microphone MIC1 or the speaker SPK1 that was turned off (that is, muted) by the user operation in the processing of step St65 from ON to OFF (St67). On the other hand, when the howling detector HWD determines that no howling is detected in the processing of step St66 (St66, NO), the howling detector HWD outputs a howling detection result to the cause flag determination unit 144A. Based on the howling detection result, the cause flag determination unit 144A maintains a cause flag of the microphone MIC1 or the speaker SPK1 that was turned off (that is, muted) by the user operation in the processing of step St65 in an ON state (St68). As a result, the PC 10 can maintain a cause flag of a device (the microphone MIC1 or the speaker SPK1) which is a howling cause in an ON state even when the device (the microphone MIC1 or the speaker SPK1) which is the howling cause is once turned off in step St65, thereafter the device is turned on by a user operation before a howling re-detection processing in step St66 is executed, and then the device is turned off again.

As described above, when the PC 10 which is an example of the voice communication apparatus according to the first embodiment is linked with another terminal (the PC 20) and it is determined that the own terminal (the PC 10) is a howling cause, the PC 10 can determine whether the howling cause is the microphone MIC1, the speaker SPK1, or both the microphone MIC1. and the speaker SPK1. In addition, the PC 10 can generate the alert screen MSG2b indicating a user operation instruction for the device that was determined to be a howling cause and displays the alert screen MSG2b on the display device 16, so that the howling cause and a howling elimination method can be presented to a user.

The cause flag determination procedure shown in FIG. 14 may be executed as an operation procedure for presenting (notifying) the howling elimination method to a user after the howling cause determination procedure in a case where the PC 10 is not linked with another PC (here, the PC 20) in the own base shown in FIG. 11. As a result, even when the PC 10 which is an example of the voice communication apparatus according to the first embodiment is not linked with another PC (here, the PC 20) in the own base, the PC 10 can generate the alert screen MSG2b indicating a user operation instruction for the device that was determined to be a howling cause and displays the alert screen MSG2b on the display device 16, so that the howling cause and a howling elimination method can be presented to a user.

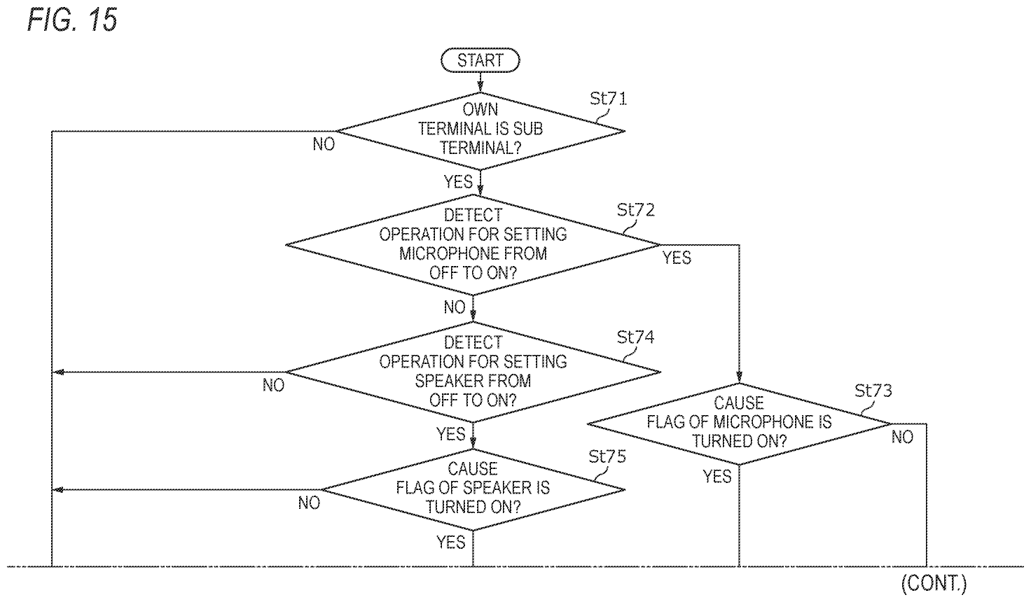

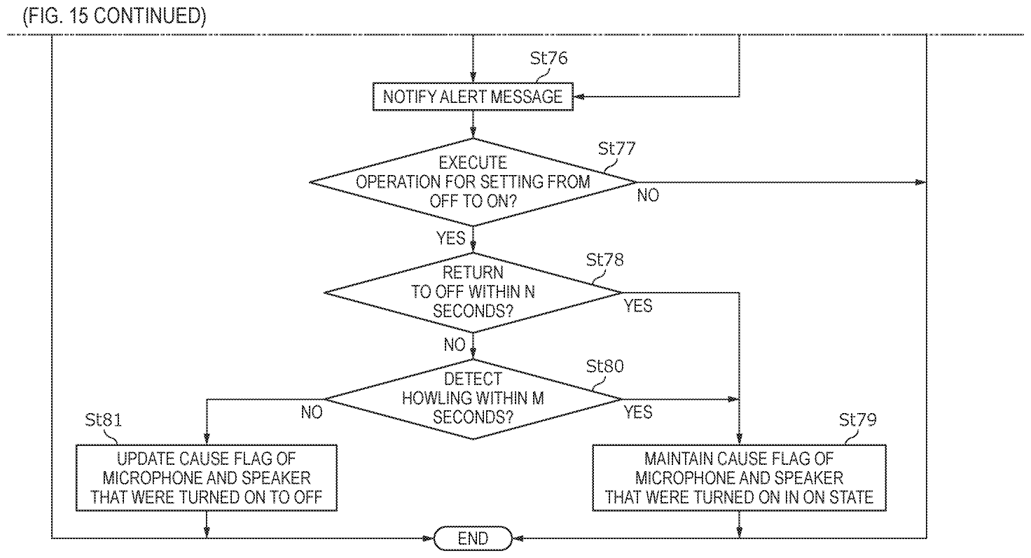

Next, a cause flag determination procedure executed by the PC 10 after the cause flag determination procedure shown in FIGS. 13 and 14 is executed will be described. FIG. 15 is a flowchart showing an example of a cause flag determination procedure of the PC 10 according to the first embodiment.

The main and sub determination unit 143E determines whether the own terminal (here, the PC 10) is currently a sub terminal (St71). Here, the main and sub determination unit 143B may determine whether the own terminal is currently a sub terminal based on a main and sub determination procedure shown in FIG. 25, or may determine whether the own terminal is currently a sub terminal based on the main and sub terminal determination result in the processing of step St100 shown in FIG. 11 or 12.

When the main and sub determination unit 143B determines in the processing of step St71 that the own terminal (the PC 10) is currently a sub terminal (St71, YES), the main and sub determination unit 143B causes the cause flag determination unit 144A to execute a cause flag determination. The cause flag determination unit 144A determines whether a user operation for setting the microphone MIC1 from OFF to ON is detected (St72). The user operation for setting the microphone MIC1 from OFF to ON is, for example, an operation of hovering a cursor position of a mouse (the operation device 12) on an icon capable of controlling ON and OFF of the microphone MIC1 displayed on the display device 16 or approaching (positioning) the cursor position in the vicinity of the icon by a user operation. On the other hand, when the main and sub determination unit 143B determines in the processing of step St71 that the own terminal (the PC 10) is currently not a sub terminal (that is, the own terminal is a main terminal) (St71, NO), the main and sub determination unit 14313 ends the cause flag determination procedure shown in FIG. 15.

When it is determined in the processing of step St72 that the user operation for setting the microphone MIC1 from OFF to ON is detected (St72, YES), the cause flag determination unit 144A determines whether a cause flag of the microphone MIC1 is currently set to ON (St73). On the other hand, when it is determined in the processing of step St72 that no user operation for setting the microphone MIC1 from OFF to ON is detected (St72, NO), the cause flag determination unit 144.A determines whether a user operation for setting the speaker SPK1 from OFF to ON is detected (St74). Here, the user operation for setting the speaker SPK1 from OFF to ON is, for example, an operation of hovering a cursor position of a mouse (the operation device 12) on an icon capable of controlling ON and OFF or a volume of the speaker SPK1 displayed on the display device 16 or approaching (positioning) the cursor position in the vicinity of the icon by a user operation.

When it is determined in the processing of step St73 that a cause flag of the microphone MIC1 is currently set to ON (St73, YES), the cause flag determination unit 144A generates the alert message MSG1c such as “howling may occur” related to a device (here, the microphone MIC1) for which a cause flag is set to ON, and outputs the alert message MSG1c to the display device 16. The display device 16 displays the alert message so as to wain (notify) a user that howling may occur again (St76). On the other hand, when the cause flag determination unit 144A determines in the processing of step St73 that the cause flag of the microphone MIC1 is not currently set to ON (St73, NO), the cause flag determination unit 144A ends the cause flag determination procedure shown in FIG. 15.

When it is determined in the processing of step St74 that the user operation for setting the speaker SPK1 from OFF to ON is detected (St74, YES), the cause flag determination unit 144A determines whether a cause flag of the speaker SPK1 is currently set to ON (St75). On the other hand, when it is determined in the processing of step St74 that no user operation for setting the speaker SPK1 from OFF to ON is detected (St74, NO), the cause flag determination unit 144A ends the cause flag determination procedure shown in FIG. 15.

When it is determined in the processing of step St75 that a cause flag of the speaker SPK1 is currently set to ON (St75, YES), the cause flag determination unit 144A generates the alert message MSG1c such as “howling may occur” related to a device (here, the speaker SPK1) for which a cause flag is set to ON, and outputs the alert message MSG1c to the display device 16. The display device 16 displays the alert message MSG1c so as to warn (notify) a user that howling may occur again (St76). On the other hand, when the cause flag determination unit 144A determines in the processing of step St75 that the cause flag of the speaker SPK1 is not currently set to ON (St75, NO), the cause flag determination unit 144A ends the cause flag determination procedure shown in FIG. 15.

After the processing of step St76, the cause flag determination unit 144A determines whether the device (the microphone MIC1 or the speaker SPK1) for which the cause flag is set to ON is set from OFF to ON based on a user operation (St77).

When the cause flag determination unit 144A determines in the processing of step St77 that the device for which the cause flag is set to ON is set from OFF to ON based on a user operation (St77, YES), the cause flag determination unit 144A determines whether the device that was turned on within N (N is a positive number equal to or larger than 1) seconds (for example, several seconds) from a timing when the device was turned on is turned off again (St78). On the other hand, when the cause flag determination unit 144A determines in the processing of step St77 that the device for which the cause flag is set to ON is not set from OFF to ON based on a user operation (St77, NO), the cause flag determination unit 144A ends the cause flag determination procedure shown in FIG. 15.

When it is determined in the processing of step St78 that the device turned on within N seconds from the timing when the device was turned on is turned off again (St78, YES), the cause flag determination unit 144A maintains the cause flag corresponding to the device that was turned on (the microphone MIC1 or the speaker SPK1) in an ON state (St79). On the other hand, when it is determined in the processing of step St78 that the device turned on within N seconds from the timing when the device was turned on is not turned off again (St78, NO), the cause flag determination unit 144A determines whether howling is detected by the howling detector HWD within M (M is a positive number equal to or larger than 1) seconds (for example, tens of seconds, several tens of seconds, or the like) after N seconds elapse (St80). Here, M may be equal to or less than N.

When it is determined in the processing of step St80 that howling is detected by the howling detector HWD within N seconds after N seconds elapse (St80, YES), the cause flag determination unit 144A maintains a cause flag corresponding to the device (the microphone MIC1 or the speaker SPK1) that was turned on in an ON state (St79). On the other hand, when it is determined in the processing of step St80 that no howling is detected by the howling detector HWD within M seconds after N seconds elapse (St80, NO), the cause flag determination unit 144A sets (updates) the cause flag corresponding to the device (the microphone MIC1 or the speaker SPKT) that was turned on to OFF (St81),

In the cause flag determination procedure described above, the processing of step St76 is not limited to being executed after the processings of step St73 and step St75, and may be executed, for example, when it is determined that the device for which a cause flag is set to ON is set from OFF to ON based on a user operation in the processing of step St77.

As described above, the PC 10 which is an example of the voice communication apparatus according to the first embodiment can warn a user that howling may occur again by displaying the alert message MSG1c when the PC 10 detects that the user intends to set a device that is a howling cause from OFF to ON. When the microphone MIC1 or the speaker SPK1 for which a cause flag was set to ON is turned on by a user operation, the PC 10 executes a howling detection again to update or maintain a current cause flag set for the microphone MIC1 or the speaker SPK1.

Here, when the cause flag determination procedure shown in FIG. 15 is executed twice or more, the twice or subsequent cause flag determination procedures (step St71 to step St81) may be executed in parallel with the cause flag determination procedure of step St54 to step St55 shown in FIG. 13 or the cause flag determination procedure of step St61 to step St68 shown in FIG. 14.

Next, a main and sub determination processing (first time) will be described with reference to FIG. 16. FIG. 16 is a flowchart showing an example of a first time main and sub determination procedure of the PC 10 according to the first embodiment.

The main and sub determination unit 143B determines whether a speaker phone is connected to an own terminal (here, the PC 10) (St101).

When the main and sub determination unit 143B determines in the processing of step St101 that the speaker phone is connected to the own terminal (the PC 10) (St101, YES), the main and sub determination unit 143B sets the own terminal (the PC 10) as a main terminal (St102). On the other hand, when the main and sub determination unit 143B determines in the processing of step St101 that no speaker phone is connected to the own terminal (the PC 10) (St101, NO), the main and sub determination unit 143B acquires information indicating the number of PCs connected to the own terminal (the PC 10) among a plurality of PCs connected to the same web conference from an own base (that is, a connection order to the web conference in the own base) (St103).

Based on the acquired information, the main and sub determination unit 143B determines whether the own terminal (the PC 10) is a first terminal (that is, a first one) in the own base (St104).

When the main and sub determination unit 143B determines in the processing of step St104 that the own terminal (the PC 10) is the first terminal (that is, the first one) in the own base (St104, YES), the main and sub determination unit 143B determines whether the microphone MIC1 of the own terminal (the PC 10) is turned on (St105). Here, the main and sub determination unit 143B may shift to a processing of step St109 and set the own terminal (the PC 10) as a main terminal (St109). When the main and sub determination unit 143B determines in the own base in the processing of step St104 that the own terminal (the PC 10) is not the first terminal (that is, the first one) (St104, NO), the main and sub determination unit 143B temporarily sets the own terminal (the PC 10) as a sub terminal (St106), and waits for the main and sub determination processing of the own terminal (the PC 10) until the main and sub determination unit 143B receives a main terminal setting instruction from another terminal (here, the PC 20) in the own base (St107). After the processing of step St107, when the main and sub determination unit 143B receives the main terminal setting instruction from the other terminal (the PC 20) in the own base, the main and sub determination unit 143B sets the own terminal (the PC 10) as a main terminal.

When the main and sub determination unit 143B determines in the processing of step St105 that the microphone MIC1 of the own terminal (the PC 10) is turned on (St105, YES), the main and sub determination unit 143B determines whether the speaker SPK1 of the own terminal (the PC 10) is turned on (St108). When the main and sub determination unit 143B determines in the processing of step St105 that the microphone MIC1 of the own terminal (the PC 10) is not turned on (St105, NO), the main and sub determination unit 143B sets the own terminal (the PC 10) as a sub terminal (Sti10), and transmits the main terminal setting instruction to a subsequent terminal in the own base (St111). The subsequent terminal referred to here may be another terminal (PC), or may be a subsequent terminal (PC) according to a connection order in the own base. In addition, when the connection order of the subsequent terminal indicates that the subsequent terminal is a last terminal, the PC 10 may transmit the connection order to the first terminal (PC) according to the connection order.

When the main and sub determination unit 143B determines in the processing of step St108 that the speaker SPK1 of the own terminal (the PC 10) is turned on (St108, YES), the main and sub determination unit 143B sets the own terminal (the PC 10) as a main terminal (St109).

When the PC 10 is not linked with another terminal in the own base (that is, the own terminal status information and the other terminal status information to cannot be transmitted or received between the own terminal and the other terminal arranged the own base), the PC 10 may set the own terminal as a sub terminal in the processings of step St106 and step St110, and may omit the processings of step St107 and step St111. As a result, the PC 10 can determine whether the own terminal is a main terminal or a sub terminal even when the PC 10 is not linked with another terminal in the own base.

As described above, the PC 10 Which is an example of the voice communication apparatus according to the first embodiment can determine whether the own terminal is a main terminal or a sub terminal.

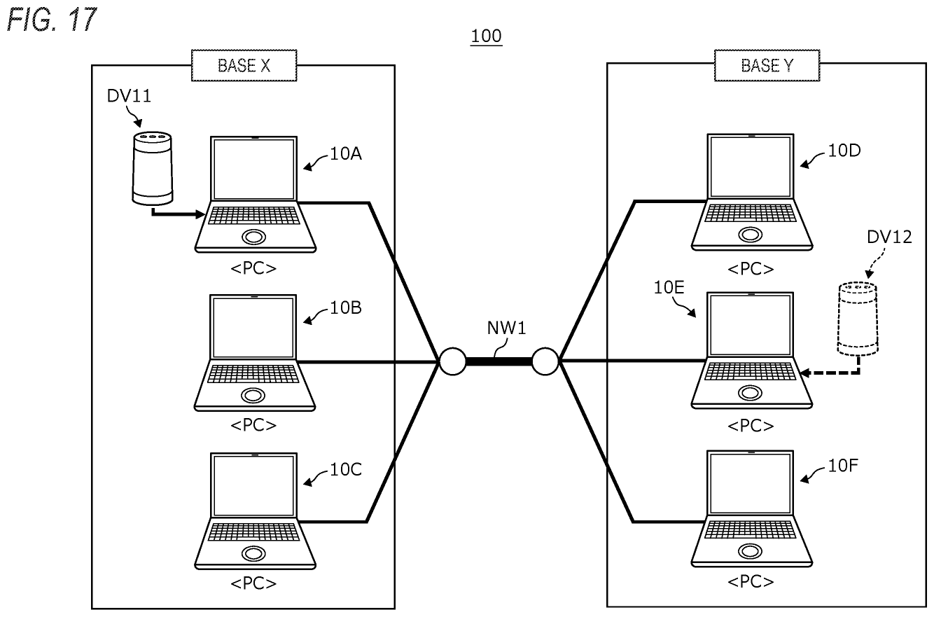

A first use case of the web conference system 100 according to the first embodiment will be described with reference to FIG. 17. FIG. 17 is a diagram showing a first use case of the web conference system 100 according to the first embodiment. The first use case of the web conference system 100 shown in FIG. 17 is an example, and it is needless to say that the present invention is not limited thereto.

The first use case shows an example in which each of three PCs 10A, 10B, and 10C in a base X and each of three PCs 10D, 10E, and 10F in a base Y are connected to the network NW1, and a web conference provided by the web conference system 100 is started, in the first use case, a speaker phone DV11 is connected to the PC 10A in the base X, and a speaker phone DV12 is connected to the PC 10E in the base Y during the web conference.

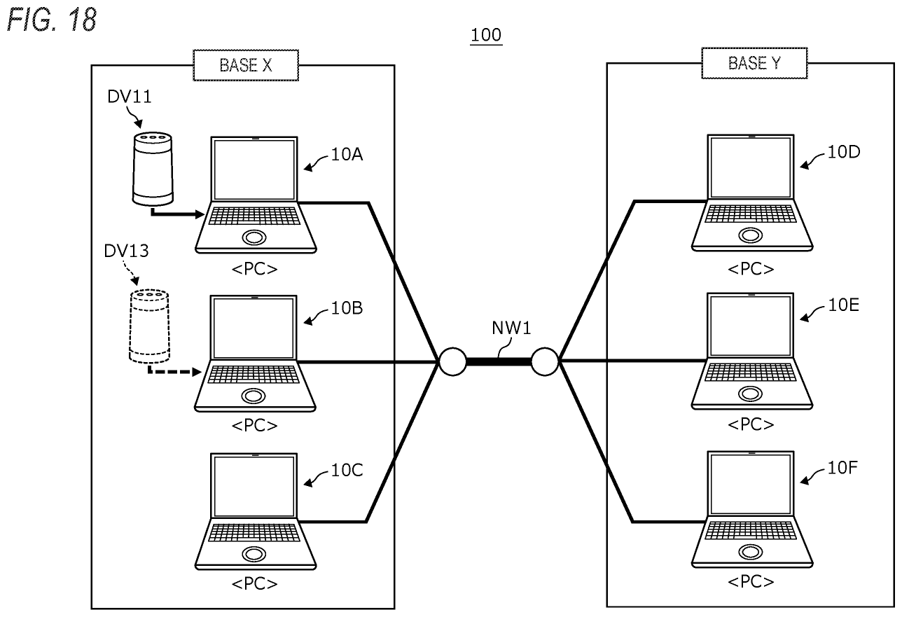

A second use case of the web conference system 100 according to the first embodiment will be described with reference to FIG. 18. FIG. 18 is a diagram showing a second use case of the web conference system 100 according to the first embodiment. The second use case of the web conference system 100 shown in FIG. 18 is an example, and it is needless to say that the present invention is not limited thereto.

The second use case shows an example in which each of the three PCs 10A, 10B, and 10C in the base X and each of the three PCs 10D, 10E, and 10F in the base Y are connected to the network NW1, and the web conference provided by the web conference system 100 is started. In the second use case, in the base X, the speaker phone DV11 is connected to the PC 10A when the web conference is started, and a speaker phone DV13 is newly connected to the PC 10B in the middle of the web conference.

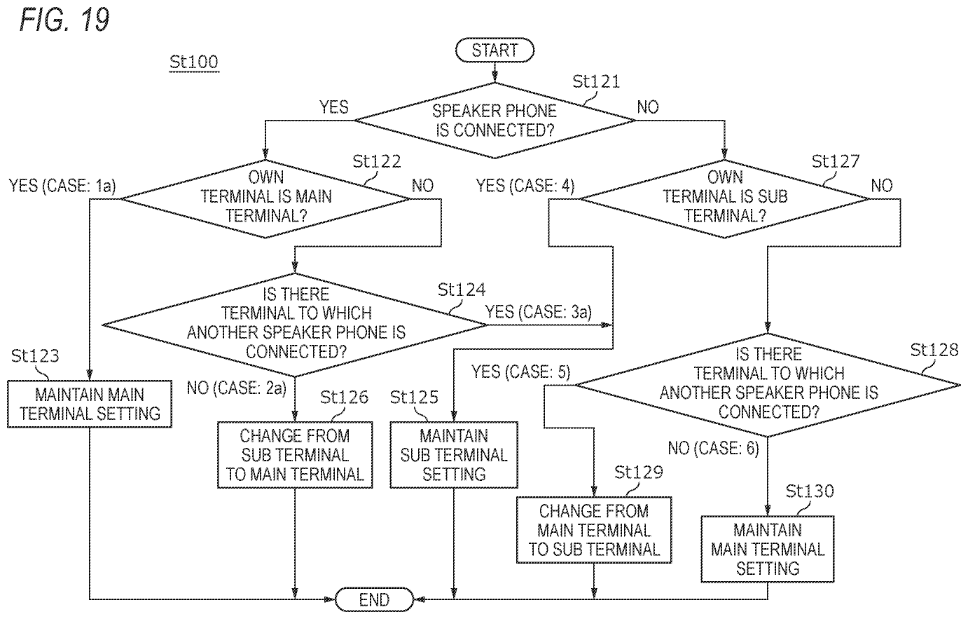

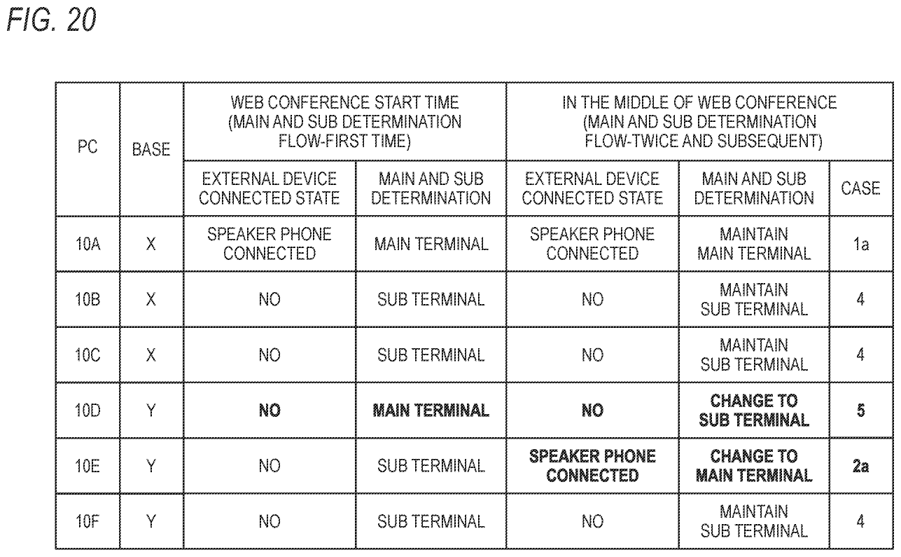

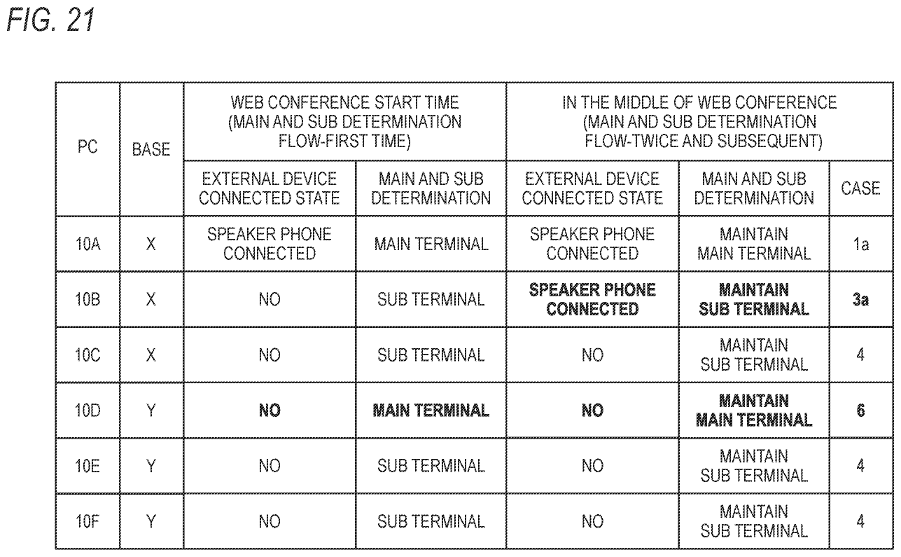

Next, the main and sub determination processing (twice and subsequent) will be described with reference to FIGS. 19 to 21. FIG. 19 is a flowchart showing an example of twice and subsequent first main and sub determination procedures of the PC 10 according to the first embodiment. FIG. 20 is a diagram showing details of the first use case of the web conference system 100 according to the first embodiment. FIG. 21 is a diagram showing details of the first use case of the web conference system 100 according to the first embodiment. The first use cases shown in FIGS. 20 and 21 are examples, and the present invention is not limited thereto. The first main and sub determination procedure is a main and sub determination procedure executed when main terminal setting of a PC that was set as a main terminal by a first time main and sub determination is preferentially maintained.

The main and sub determination unit 143B determines whether a speaker phone is connected to the own terminal (here, the PC 10) (St121).

When the main and sub determination unit 143B determines in the processing of step St121 that the speaker phone is connected to the own terminal (the PC 10) (St121, YES), the main and sub determination unit 143B determines whether the own terminal (the PC 10) is set as a main terminal (St122). On the other hand, when the main and sub determination unit 143B determines in the processing of step St121 that no speaker phone is connected to the own terminal (the PC 10) (St121, NO), the main and sub determination unit 143B determines whether the own terminal (the PC 10) is set as a sub terminal (St127).

When the main and sub determination unit 143B determines in the processing of step St122 that the own terminal (the PC 10) is set as a main terminal (St122, YES), the main and sub determination unit 143B maintains the selling of the main terminal set in the own terminal (the PC 10) (St123).

Here, a specific example (Case: 1a in FIG. 20 and FIG. 21) in which the processing proceeds from step St122 to step St123 will be described with reference to the first use case. For example, the PC 10.A shown in the first use case is connected to the speaker phone DV11 which is an external device at a start time of the web conference (that is, at the time when a first time main and sub determination processing is executed), and the PC 10A is set as a main terminal. When the main and sub determination unit 143B of the PC 10A determines that the speaker phone DV11 serving as an external device is connected to the PC 10A and the PC 10A is set as a main terminal in the same manner in the middle of the web conference (that is, at the time when twice and subsequent main and sub determination processings are executed), the main and sub determination unit 143B maintains the main terminal setting of the own terminal (here, the PC 10A).

On the other hand, when the main and sub determination unit 143B determines in the processing of step St122 that the own terminal (the PC 10) is not set as a main terminal (that is, the own terminal is set as a sub terminal) (St122, NO), the main and sub determination unit 143E determines whether there is another terminal to which another speaker phone in the own base is connected (St124).

When the main and sub determination unit 143B determines in the processing of step St124 that there is another terminal to which another speaker phone in the own base is connected (St124, YES), the main and sub determination unit 143B maintains sub terminal setting of the own terminal (the PC 10) (St125).

Here, a specific example (Case: 3a in FIG. 21) in which the processing proceeds from step St12%1 to step St125 will be described with reference to the second use case. For example, the PC 10B shown in the second use case is not connected to a speaker phone that is an external device at a start time of the web conference (that is, at the time when the time first main and sub determination processing is executed), and the PC 10B is set as a sub terminal. When the main and sub determination unit 143B of the PC 10B determines that the speaker phone DV13 serving as an external device is newly connected in the middle of the web conference (that is, at the time when twice and subsequent main and sub determination processings are executed) and the PC 10B is set as a sub terminal, the main and sub determination unit 143B maintains sub terminal setting of the own terminal (here, the PC 10B). At this time, a main terminal in the base X is the PC 10A.

On the other hand, when the main and sub determination unit 143B determines in the processing of step St124 that there is no another terminal to which another speaker phone is connected in the own base (St124, NO), the main and sub determination unit 143B changes setting of the own terminal (the PC 10) from a sub terminal to a main terminal (St126).

Here, a specific example (Case: 2a in FIG. 20) in which the processing proceeds from step St124 to step St126 will be described with reference to the first use case. For example. the PC 10E shown in the first use case is not connected to a speaker phone that is an external device at a start time of the web conference (that is, at the time when the first time main and sub determination processing is executed). and the PC 10E is set as a sub terminal. When the main and sub determination unit 143B of the PC 10E determines that the speaker phone DV12 serving as an external device is newly connected in the middle of the web conference (that is, at the time when twice and subsequent main and sub determination processings are executed) and the PC 10E is set as a sub terminal, the main and sub determination unit 143E changes the own terminal (here, the PC 10B) from a sub terminal to a main terminal. That is, a main terminal in the base Y is changed from the PC 10D to the PC 10E.

When the main and sub determination unit 143B determines in the processing of step St127 that the own terminal (the PC 10) is set as a sub terminal (St127, YES), the main and sub determination unit 143B maintains sub terminal setting of the own terminal (the PC 10) (St125). Here, a specific example (Case: 4 in FIG. 20 and FIG. 21) in which the processing proceeds from step St127 to step St125 will be described with reference to the first use case. For example, the PC 10B shown in the first use case is not connected to a speaker phone that is an external device at a start time of the web conference (that is, at the time when the first time main and sub determination processing is executed), and the PC 10B is set as a sub terminal. When the main and sub determination unit 143B of the PC lob determines that no speaker phone is connected to the PC 10B in the same manner in the middle of the web conference (that is, at the time when twice and subsequent main and sub determination processings are executed) and the PC 10B is set as a sub terminal, the main and sub determination unit 143B maintains sub terminal setting of the own terminal (here, the PC 10B). The specific example (Case: 4) in which the processing proceeds from step St127 to step St125 is the same for the other PCs, and thus description thereof will be omitted here.

When the main and sub determination unit 143B determines in the processing of step St127 that the own terminal (the PC 10) is not set as a sub terminal (St127, NO), the main and. sub determination unit 143B determines whether there is another terminal to which another speaker phone in the own base is connected (St128).

When the main and sub determination unit 143B determines in the processing of step St128 that there is another terminal to which another speaker phone in the own base is connected (St128, YES), the main and sub determination unit 143B changes setting of the own terminal (the PC 10) from a main terminal to a sub terminal (S1129).

Here, a specific example (Case: 5 in FIG. 20) in which the processing proceeds from step St128 to step St129 will be described with reference to the first use case. For example, the PC 10D shown in the first use case is not connected to a speaker phone that is an external device at a start time of the web conference (that is, at the time when the first time main and sub determination. processing is executed), and the PC 10D is set as a main terminal. When the main and sub determination unit 143B of the PC 10D determines that the speaker phone DV12 is newly connected to another terminal (here, the PC 10E) in the middle of the web conference (that is, at the time when the twice and subsequent main and sub determination processings are executed) and no speaker phone is connected to the own terminal (the PC 10D), the main and sub determination unit 143B of the PC 10D changes the setting of the own terminal (the PC 10D) from a main terminal to a sub terminal. That is, a main terminal in the base Y is changed from the PC 10D to the PC 10E.

On the other hand, when the main and sub determination unit 143B determines in the processing of step St128 that there is no another terminal to which another speaker phone in the own base is connected (St128, NO), the main and sub determination unit 143B maintains the main terminal setting of the own terminal (the PC 10) (St130).

Here, a specific example (Case: 6 in FIG. 21) in which the processing proceeds from step St128 to step St130 will be described with reference to the first use case. For example, the PC 10D shown in the second use case is not connected to a speaker phone that is an external device at a start time of the web conference (that is, at the time When the first time main and sub determination processing is executed), and the PC 10D is set as a main terminal. When the main and sub determination unit 143B of the PC 10D determines that no speaker phone is newly connected to either the own terminal or another terminal in the middle of the web conference (that is, at the time when the twice and subsequent main and sub determination processings are executed) and the own terminal (the PC 10D) is set as a main terminal, the main and sub determination unit 143B of the PC 10D maintains the main terminal setting of the own terminal (PC 10D).

As described above, the PC 10 which is an example of the voice communication apparatus according to the first embodiment can periodically execute a main and sub determination processing even alter the web conference is started, based on a first time main and sub determination processing result and a connection state of a speaker phone in the own base. As a result, the web conference system 100 can make setting (main setting or sub setting) corresponding to each PC in accordance with a stale of each of one or more PCs arranged in each base.

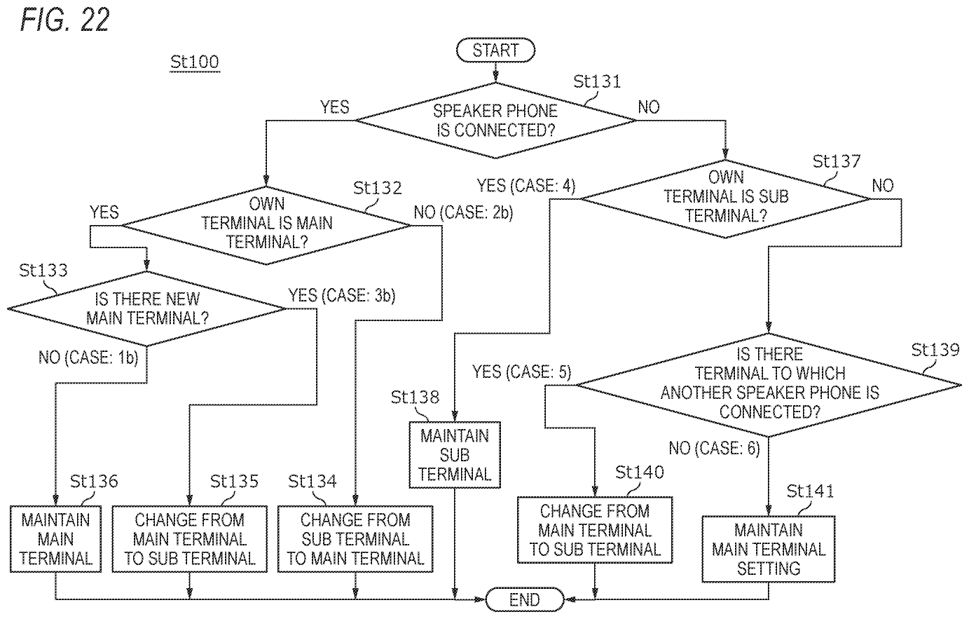

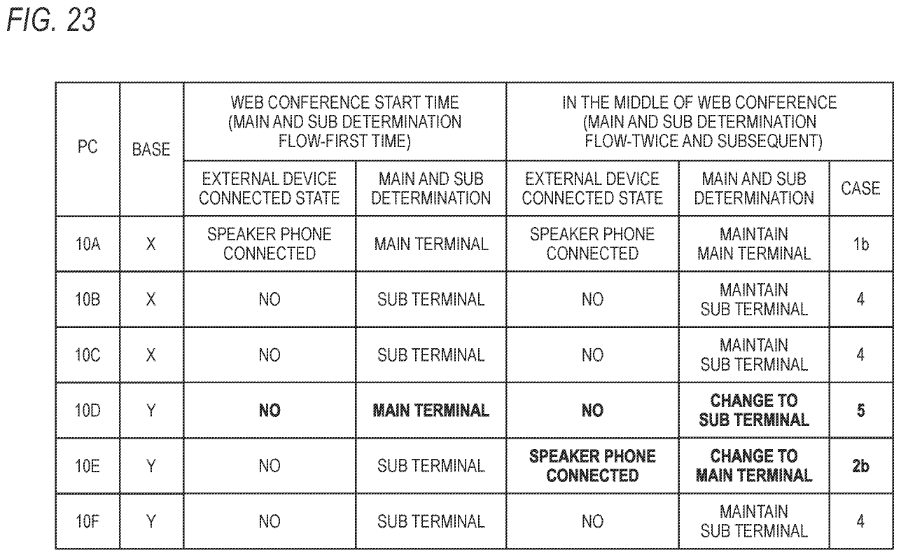

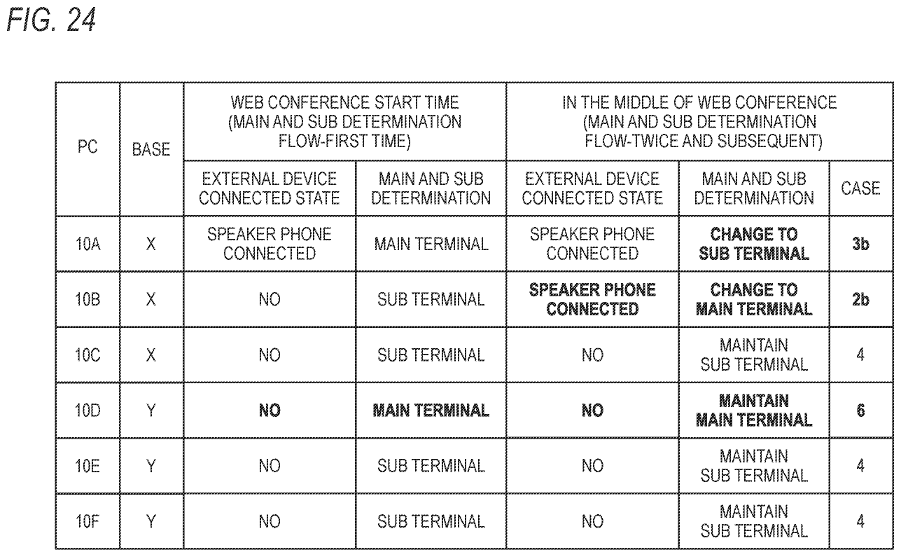

Next, the main and sub determination processing (twice and subsequent) will be described with reference to FIGS. 22 to 24. FIG. 22 is a flowchart showing an example of twice and subsequent second main and sub determination procedures of the PC 10 according to the first embodiment. FIG. 23 is a diagram showing details of the second use case of the web conference system 100 according to the first embodiment. FIG. 24 is a diagram showing details of the second use case of the web conference system 100 according to the first embodiment. The second use cases shown in FIGS. 23 and 24 are examples, and the present invention is not limited thereto. The second main and sub determination procedure is a main and sub determination procedure executed when a PC that is newly determined to be a main terminal by twice and subsequent main and sub determinations is preferentially set as a main terminal.

The main and sub determination unit 143B determines whether a speaker phone is connected to the own terminal (here, the PC 10) (St131).

When the main and sub determination unit 143B determines in the processing of step St131 that the speaker phone is connected to the own terminal (the PC 10) (St131, YES), the main and sub determination unit 1431-3 determines whether the own terminal (the PC 10) is set as a main terminal (St132). On the other hand, when the main and sub determination unit 143B determines in the processing of step St131 that no speaker phone is connected to the own terminal (the PC 10) (St131, NO). the main and sub determination unit 143B determines whether the own terminal (the PC 10) is set as a sub terminal (St137).

When the main and sub determination unit 143B determines in the processing of step St132 that the own terminal (the PC 10) is set as a main terminal (St132, YES), the main and sub determination unit I43B acquires another terminal status information of another terminal arranged in the own base, and determines whether there is another terminal that is newly set as a main terminal (St133). On the other hand, when it is determined in the processing of step Sti32 that the own terminal (the PC 10) is not set as a main terminal (that is, the own terminal is set as a sub terminal) (St132, NO), the setting of the own terminal (the PC 10) is changed from a sub terminal to a main terminal (St134).

Here, a specific example (Case: 2b in FIG. 23) in which the processing proceeds from step St132 to step St134 will be described with reference to the first use case. For example, no speaker phone is connected to the PC 10E shown in the first use case at the start time of the web conference (that is, at the time when the first time main and sub determination processing is executed), and the PC 10E is set as a sub terminal. When the main and sub determination unit 143B of the PC 10E determines that the speaker phone DV12 serving as an external device is newly connected in the middle of the web conference (that is, at the time when the twice and subsequent main and sub determination processings are executed) and the PC 10E is set as a sub terminal, the main and sub determination unit 143B determines that the own terminal (here. the PC 10E) is a new main terminal and sets the own terminal (here, the PC 10E) as a main terminal.

Similarly, a specific example (Case: 2b FIG. 24) in which the processing proceeds from step St132 to step St134 will be described with reference to the second use case. For example, no speaker phone is connected to the PC 10B shown in the second use case at the start time of the web conference (that is, at the time when the first time main and sub determination processing is executed), and the PC 10B is set as a sub terminal. When the main and sub determination unit 143B of the PC 10B determines that the speaker phone DV13 serving as an external device is newly connected in the middle of the web conference (that is, at the time when the twice and subsequent main and sub determination processings are executed), the main and sub determination unit 143B determines that the own terminal (here, the PC 10B) is a new main terminal and sets the own terminal (here, the PC 10B) as a main terminal.

When the main and sub determination unit 143B determines in the processing of step St133 that there is another terminal newly set as a main terminal (St133, YES), the main and sub determination unit 143B changes the setting of the own terminal (the PC 10) from a main terminal to a sub terminal (St135).

Here, a specific example (Case: 3b in FIG. 24) in which the processing proceeds from step St133 to step St135 will be described with reference to the second use case. For example, the PC 10A shown in the second use case is connected to the speaker phone DV11 at a start time of the web conference (that is, at the time when the first time main and sub determination processing is executed), and the PC 10A is set as a main terminal. When the main and sub determination unit 143B of the PC 10A determines that the PC 10B is newly set as a main terminal based on the other terminal status information transmitted from the PC 10B in the middle of the web conference (that is, at the time when the twice and subsequent main and sub determination processings are executed), the main and sub determination unit 143B sets the own terminal (here, the PC 10A) as a sub terminal.

When the main and sub determination unit 143B determines in the processing of step St133 that there is no another terminal newly set as a main terminal (St133, NO), the main and sub determination unit 143B maintains the main terminal setting of the own terminal (the PC 10) (St136).

Here, a specific example (Case: 1b in FIG. 23) in which the processing proceeds from step St133 to step St136 will be described with reference to the second use case. For example. the PC 10A shown in the second use case is connected to the speaker phone DV11 at a start time of the web conference (that is, at the time when the first time main and sub determination processing is executed), and the PC 10A is set as a main terminal. When the main and sub determination unit 143B of the PC 10A determines that the speaker phone DV11 is connected. and there is no another terminal newly set as a main terminal based on the acquired another terminal status information in the middle of the web conference (that is, at the time when the twice and subsequent main and sub determination processings are executed), the main and sub determination unit 143B maintains the main terminal setting of the own terminal (PC 10A).

When the main and sub determination unit 143B determines in the processing of step St131 that no speaker phone is connected to the own terminal (the PC 10) (St131, NO), the main and sub determination unit 143B determines whether the own terminal (the PC 10) is set as a sub terminal (St137).

When the main and sub determination unit 143B determines in the processing of step St137 that the own terminal (the PC 10) is set as a sub terminal (St137, YES), the main and sub determination unit 143B maintains the sub terminal setting of the own terminal (the PC 10) (St138).

Here, a specific example (Case: 4 in FIG. 23 and FIG. 24) in which the processing proceeds from step St137 to step St138 will be described with reference to the first use case. For example, no speaker phone is connected to the PC 10B shown in the second use case at the start time of the web conference (that is, at the time when the first time main and sub determination processing is executed), and the PC 10B is set as a sub terminal. When the main and sub determination unit 143B of the PC 10B determines that no speaker phone is connected in the middle of the web conference (that is, at the time when the twice and subsequent main and sub determination processings are executed), the main and sub determination unit 143B maintains the sub terminal setting of the own terminal (the PC 10B). The specific example (Case: 4) in which the processing proceeds from step St137 to step St138 is the same for the other PCs, and thus description thereof will be omitted here.

When the main and sub determination unit 143B in the processing of step St137 determines that the own terminal (the PC 10) is not set as a sub terminal (that is, the own terminal is set as a main terminal) (St137, NO), the main and sub determination unit 143B determines whether there is another terminal to which another speaker phone in the own base is connected (St139).

When the main and sub determination unit 143B determines in the processing of step St139 that there is another terminal to which another speaker phone in the own base is connected (St139, YES), the main and sub determination unit 143B changes the setting of the own terminal (the PC 10) from a main terminal to a sub terminal (St140).

Here, a specific example (Case: 5 in FIG. 23) in which the processing proceeds from step St139 to step St140 will be described with reference to the first use case. For example, the PC 10D shown in the first use case is not connected to a speaker phone that is an external device at a start time of the web conference (that is, at the time when the first time main and sub determination processing is executed) and the PC 10D is set as a main terminal. When the main and sub determination unit 143B of the PC 10D determines that the speaker phone DV12 is newly connected to another terminal (here, the PC 10E) and no speaker phone is connected to the own terminal (the PC 10D) based on the acquired another terminal status information in the middle of the web conference (that is, at the time when the twice and subsequent main and sub determination processings are executed), the main and sub determination unit 143B of the PC 10D changes the setting of the own terminal (the PC 10D) from a main terminal to a sub terminal. That is, a main terminal in the base is changed. from the PC 10D to the PC 10E.

On the other hand, when the main and sub determination unit 143B determines in the processing of step St139 that there is no another terminal to which another speaker phone in the own base is connected (St139, NO), the main and sub determination unit 143B maintains the main terminal setting of the own terminal (the PC 10) (St141).

Here, a specific example (Case: 6 in FIG. 24) in which the processing proceeds from step St139 to step St141 will be described with reference to the first use case. For example, the PC 101) shown in the second use case is not connected to a speaker phone that is an external device at a start time of the web conference (that is, at the time when the first time main and sub determination processing is executed), and the PC 10D is set as a main terminal. When the main and sub determination unit 143B of the PC 10D determines that no speaker phone is newly connected to either the own terminal or another terminal and the own terminal (the PC 10D) is set as a main terminal based on the acquired another terminal status information in the middle of the web conference (that is, at the time when the twice and subsequent main and sub determination processings are executed), the main and sub determination unit 143B of the PC 10D maintains the main terminal setting of the own terminal (PC 10D).

As described above, the PC 10 which is an example of the voice communication apparatus according to the first embodiment can periodically execute a main and sub determination processing even after the web conference is started, based on a first time main and sub determination processing result and a connection state of a speaker phone in the own base. As a result, the web conference system 100 can make setting (main setting or sub setting) corresponding to each PC in accordance with a state of each of one or more PCs arranged in each base.

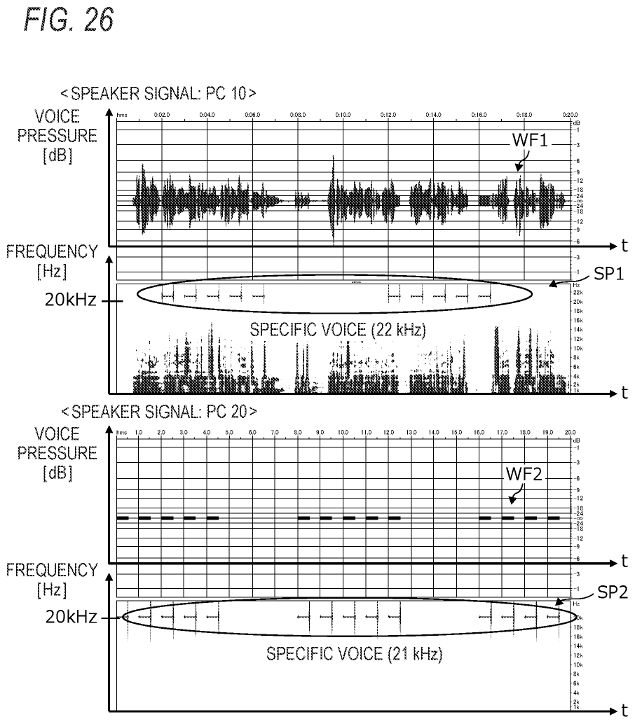

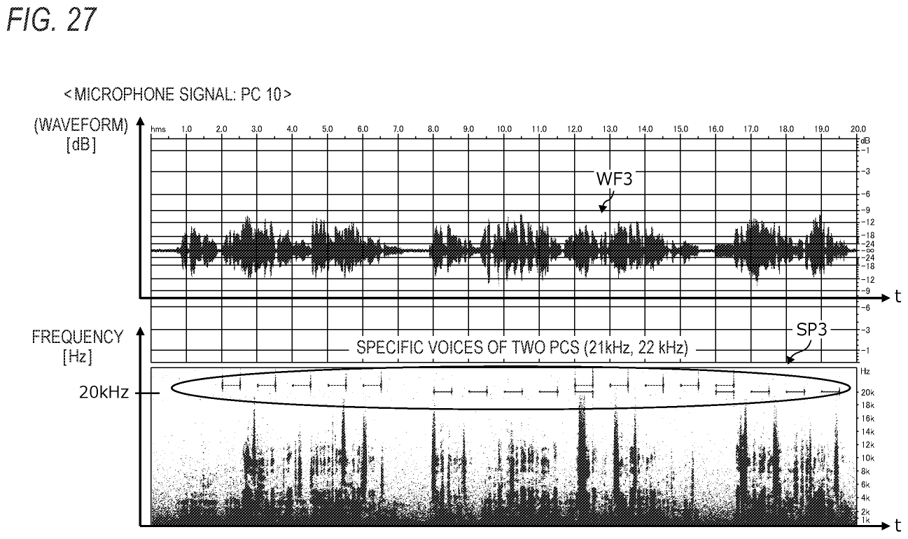

Next, an own base connected terminal number determination will be described with reference to FIGS. 25 to 27. FIG. 25 is a flowchart showing an example of a procedure for detecting another terminal in the same base as the PC 10 according to the first embodiment. FIG. 26 is a diagram showing an example of speaker signals of the two PCs 10 and 20 in the same base. FIG. 27 is a diagram showing an example of microphone signals of the two PCs 10 and 20 in the same base. FIGS. 25 to 27 shows examples in which the PC 10 is set as a main terminal and the PC 20 is set as a sub terminal.

The processor 14 of the PC 10 calculates a hash value of the own terminal based on a connection time at which the own terminal (here, the PC 10) is connected to the web conference (address), a user name of a user, and the like (St201). The processor 14 determines a frequency of a specific voice (for example, a sine wave) for specifying the own terminal based on the calculated hash value (St202). The processor 14 synthesizes a received voice and the specific voice and plays back the synthesized voice from the speaker SPK1 (St203).

Although not described here, the PC 20 also executes the same processings (steps St201 to St203). It should be noted that a frequency of the specific voice is different for each PC arranged in the own base in a predetermined frequency band (for example, 20 kHz or more).

A voice signal WF1 shown in FIG. 26 is a signal obtained by synthesizing the received voice and the specific voice that are played back from the speaker SPK1 of the PC 10. A frequency domain signal SP1 is a signal obtained by converting the voice signal WF1 into a frequency domain. A frequency of the specific voice played back from the speaker SPK1 of the PC 10 is, for example, 22 kHz.

A voice signal WF2 shown in FIG. 26 is a signal obtained by synthesizing the received voice and the specific voice that are played back from the speaker SPK2 of the PC 20. A frequency domain signal SP2 is a signal obtained by converting the voice signal WF2 into a frequency domain. A frequency of the specific voice played back from the speaker SPK2 of the PC 20 is, for example, 21 kHz.

The processor 14 of the PC 10 converts a voice collected by the microphone MIC1 into a microphone input signal, and further converts a microphone input signal WF3 after the conversion into a frequency domain signal SP3 (St204). The processor 14 analyzes the converted frequency domain signal SP3 (St205). Based on the analysis result, the processor 14 detects a specific voice of each of the PCs 10 and 20 arranged in the own base from the frequency domain signal SP3. The processor 14 determines whether the detected specific voice is only the specific voice of the own terminal (St206).

When the processor 14 of the PC 10 determines in the processing of step St206 that the detected specific voice is only the specific voice of the own terminal (St206, YES), the processor 14 of the PC 10 determines that the ow base connected terminal number is one (St207). Here, even in a case where there are a plurality of terminals (that is, connected terminals) arranged in the own base and the other terminal status information is received, when the processor 14 determines that the detected specific voice is only the specific voice of the own terminal, the processor 14 may determine that the own base connected terminal number is one. As a result, the PC 10 can determine that a terminal whose speaker that may cause howling in the own base is turned on is only the own terminal (the PC 10).

When the processor 14 of the PC 10 determines in the processing of step St206 that the detected specific voice is not only the specific voice of the own terminal (St206, NO), the processor 14 of the PC 10 determines that the own base connected terminal number is plural (St208). Here, the processor 14 may further analyze how many terminals are connected in the own base based on an analysis result.

For example, in the example shown in FIG. 27. the processor 14 analyzes a signal in a predetermined frequency band (for example, a frequency of 20 kHz or more) from the frequency domain signal SP3. When the specific voice of 21 kHz and the specific voice of 22 kHz is detected based on the analysis result, the processor 14 determines that the own base connected terminal number is plural (specifically, two or more). When the processor 14 detects only the specific voice of 22 kHz based on the analysis result, the processor 14 determines that the own base connected terminal number is one.

A frequency band of the frequency of the specific voice described above may be different for each base. For example, the web conference system 100 may set a frequency band for each base such that a frequency band of a specific voice of a terminal (the PC10 and the PC20) arranged in the base B1 shown in FIG. 1 is 20 kHz to 29 kHz, and a frequency band of a specific voice of a terminal (the PC30) arranged in the base B2 is 30 kHz to 39 kHz. As a result, even when a microphone collects a specific voice played back by a PC arranged in another base, the own base connected terminal number can be more effectively determined.

As described above, the PC 10 which is an example of the voice communication apparatus according to the first embodiment can determine whether the own base connected terminal number of terminals connected to the same web conference from the own base is only the own terminal (that is, one terminal) even in a case where another terminal (for example, the PC 20) arranged in the own base is not connected to the same network NW1 (for example, in a case where there is a terminal connected by using tethering or the like).

The howling detection processing shown in FIG. 9 and FIG. 10 and the howling cause determination processing shown in FIGS. 11 to 15 may be executed at a timing when the setting of the own terminal is changed from a main terminal to a sub terminal or from a sub terminal to a main terminal by the twice and subsequent main and sub determination processings shown in FIG. 19 and FIG. 22.

As described above, the PC 10 which is an example of a voice communication apparatus according to the first embodiment can be connected to a voice conference in which a plurality of terminals participate. In each of the terminal, a voice input and a voice output can be freely controlled to ON or OFF by a user operation. The PC 10 which is an example of a voice communication apparatus according to the first embodiment includes the communication interface 15 (an example of a communication interface) configured to communicate with one or more another terminals (for example, the PC 30) via the network NW1, the microphone MIC1 configured to acquire a first voice signal based on an utterance of a speaker (a voice of the PC 10 user), the speaker SPK1 configured to output a second voice signal that is received by the communication interface 15 and is output from another terminal, the voice signal processing unit 141 configured to detect whether there is howling based on the first voice signal and the second voice signal, the cause determination unit 143 (an example of a control unit) configured to determine whether a howling cause is the microphone MIC1 or the speaker SPK1, and the alert notification unit 144 configured to generate the alert screen MSG2b (see FIG. 3) and output the alert screen MSG2b when it is determined that the microphone MIC1 or the speaker SPK1 is the howling cause. The PC 10 which is an example of a voice communication apparatus according to the first embodiment can be connected to a voice conference in which a plurality of terminals participate. In each of the terminal, a voice input and a voice output can be freely controlled to ON or OFF by a user operation. The PC 10 which is an example of a voice communication apparatus according to the first embodiment includes the communication interface 15 (an example of a communication interface) configured to communicate with one or more another terminals (for example, the PC 30) via the network NW1, the voice signal processing unit 141 configured to acquire a first voice signal collected by the microphone MIC1 that is an example of a device connected to a voice input terminal, acquire a second voice signal that is output from another terminal and is input to the speaker SPK1 that is an example of a device connected to a voice output terminal, and detects whether there is howling based on the first voice signal and the second voice signal, the cause determination unit 143 (an example of a control unit) configured to determine whether a howling cause is the microphone MIC1 or the speaker SPK1 based on a detection result of the voice signal processing unit 141, and the alert notification unit 144 configured to generate the alert screen MSG2b (see FIG. 3) and output the alert screen MSG2b when it is determined that the microphone MIC1 or the speaker SPK1 is the howling cause.

As a result, the PC 10 according to the first embodiment can present a howling cause to a user by generating the alert screen MSG2b indicating the determined howling cause and displaying the alert screen MSG2b on the display device 16. The voice communication apparatus is not limited to the PC 10 which is an example of the voice communication apparatus according to the first embodiment, and may be an information terminal such as a tablet and a smartphone. The voice communication apparatus may include a voice input terminal or a voice output terminal, a voice input device such as a microphone may be connected to the voice input terminal, and a voice output device such as a speaker may be connected to the voice output terminal. The voice communication apparatus may be a voice communication system including a server. The voice communication apparatus having such a configuration can also present a howling cause to a user.

As described above, in the PC 10 according to the first embodiment, at least one own base terminal including the own terminal (that is, a terminal arranged in the own base, for example, the PCs 10 and 20) is connected to the network NW1 and is arranged in the own base in which the own terminal (the PC 10) is arranged. The cause determination unit 143 determines whether the own terminal among own base terminals (for example, the PCs 10 and 20) is a main terminal, When it is determined that the own base terminal is not a main terminal, the cause determination unit 143 determines whether the microphone MIC1 or the speaker SPK1 is turned on, and according to the determination, the cause determination unit 143 determines that the microphone MIC1 or the speaker SPK1 that was determined to be turned. on is a howling cause. As described above, in the PC 10 according to the first embodiment, at least one own base terminal including the own terminal (that is, a terminal arranged in the own base, for example, the PCs 10 and 20) is connected to the network NW1 and is arranged in the own base in which the own terminal (the PC 10) is arranged. The cause determination unit 143 determines whether the own terminal among the own base terminals (for example, the PCs 10 and 20) is a main terminal. When it is determined that the own base terminal is not a main terminal, the cause determination unit 143 determines whether the microphone MIC1 which is an example of a device connected to the voice input terminal or the speaker SPK1 which is an example of a device connected to the voice output terminal is turned on, and according to the determination, the cause determination unit 143 determines that the microphone MIC1 or the speaker SPK1 that was determined to be turned on is a howling cause. As a result, the PC 10 according to the first embodiment can determine a howling cause even when the PC 10 is not linked with another terminal (the PC 20) arranged in the own base.

As described above, the communication interface 15 of the PC 10 according to the first embodiment acquires another terminal status information (an example of howling information) detected by another own base terminal (for example, the PC 20) that is different from the own terminal. The cause determination unit 143 determines whether the own terminal is a main terminal based on the acquired another terminal status information, and determines a howling cause when it is determined that the own terminal is not a main terminal. As a result, when the PC 10 according to the first embodiment is linked with another terminal (the PC 20), the PC 10 can determine a howling cause based on the other terminal status information transmitted from the other terminal (the PC 20),

As described above, the PC 10 according to the first embodiment further includes the operation device 12 (an example of an input unit) capable of receiving a user operation on the microphone MIC1 or the speaker SPK1 provided in the own terminal. The alert notification unit 144 generates and outputs the alert screen MSG2b (an example of an instruction screen) for turning off the microphone MIC1 or the speaker SPK1 that was determined to be a howling cause. The PC 10 according to the first embodiment further includes the operation device 12 (an example of an input unit) capable of receiving a user operation on the microphone MIC1 which is an example of a device connected to a voice input terminal provided in the own terminal or a speaker SPK1 which is an example of a device connected to a voice output terminal provided in the own terminal. The alert notification unit 144 generates and outputs the alert screen MSG2b (an example of an instruction screen) for turning off the microphone MIC1 or the speaker SPK1 that was determined to be a howling cause. As a result, the PC 10 according to the first embodiment generates the alert screen MSG2b (an example of an instruction screen) indicating a user operation instruction for a howling cause device (the microphone MIC1 or the speaker SPK1) that was determined to be a howling cause, and displays the alert screen MSG2b on the display device 16, so that the PC 10 can present a howling cause and a howling elimination method to a user.

As described above, when the voice signal processing unit 141 of the PC 10 according to the first embodiment determines that the microphone MIC1 or the speaker SPK1 that was determined to be a howling cause is turned off by a user operation, the voice signal processing unit 141 detects whether there is howling again. When the voice signal processing unit 141 of the PC 10 according to the first embodiment determines that the microphone MIC1 that is an example of a device connected to a voice input terminal and was determined to be a howling cause or the speaker SPK1 that is an example of a device connected to a voice output terminal and was determined to be a howling cause is turned off by a user operation, the voice signal processing unit 141 detects whether there is howling again. As a result, when there is a user operation for turning off the device that is a howling cause, the PC 10 according to the first embodiment can re-determine whether another device (the microphone MIC1 or the speaker SPK1) that is not turned off by a user operation is a howling cause by executing a howling detection processing again.

As described above, after the microphone MIC1 or the speaker SPK1 is turned off by a user operation, the cause determination unit 143 of the PC 10 according to the first embodiment determines that the microphone MIC1 or the speaker SPK1 that was determined to be a howling cause is a howling cause. After the microphone MIC1 which is an example of a device connected to a voice input terminal or the speaker SPK1 which is an example of a device connected to a voice output terminal is turned off by a user operation, the cause determination unit 143 of the PC 10 according to the first embodiment determines that the microphone MIC1 or the speaker SPK1 that was determined to be a howling cause is a howling cause. As a result, the PC 10 according to the first embodiment can determine that howling is eliminated when the microphone MIC1 or the speaker SPK1 is turned off.

As described above, after the microphone MIC1 or the speaker SPK1 is turned off by a user operation, when the cause determination unit 143 of the PC 10 according to the first embodiment determines that the microphone MIC1 or the speaker SPK1 that was determined to be a howling cause is turned on by a user operation, the cause determination unit 143 outputs information about the microphone MIC1 or the speaker SPK1 that was turned on to the alert notification unit 144. The alert notification unit 144 generates and outputs the alert message MSG1c (see FIG. 3) for warning the re-occurrence of howling based on the output information. After the microphone MIC1 that is an example of a device connected to the voice input terminal and was determined to be a howling cause or the speaker SPK1 that is an example of a device connected to the voice output terminal and was determined to be a howling cause is turned off by a user operation, when the cause determination unit 143 of the PC 10 according to the first embodiment determines that the microphone MIC1 or the speaker SPK1 is turned on by a user operation, the cause determination unit 143 outputs information about the microphone MIC1 or the speaker SPK1 that was turned on to the alert notification unit 144. The alert notification unit 144 generates and outputs the alert message MSG1c (see FIG. 3) for warning the re-occurrence of howling based on the output information. As a result, the PC 10 according to the first embodiment can warn a user that howling may occur again by displaying the alert message MSG1c when the PC 10 detects that the user intends to set a device that is a howling cause from OFF to ON.

As described above, the cause determination unit 143 of the PC 10 according to the first embodiment determines whether a pointer position based on a user operation is located in the vicinity of an icon capable of turning on the microphone MIC1 or the speaker SPK1 that was determined to be a howling cause. When it is determined that the pointer position is located in the vicinity of the icon, the cause determination unit 143 causes the alert notification unit 144 to output the alert message MSG1c. The cause determination unit 143 of the PC 10 according to the first embodiment determines whether a pointer position based on a user operation is located in the vicinity of an icon capable of turning on the microphone MIC1 that is an example of a device connected to a voice input terminal and was determined to be a howling cause or the speaker SPK1 that is an example of a device connected to a voice output terminal and was determined to be a howling cause. When it is determined that the pointer position is located in the vicinity of the icon, the cause determination unit 143 causes the alert notification unit 144 to output the alert message MSG1c. As a result, the PC 10 according to the first embodiment can determine that a user intends to turn on the device that was determined to be a howling cause based on the pointer position based on a user operation, and can output the alert message MSG1c to the display device 16 to warn a user that howling is likely to occur again.

As described above, when the cause determination unit 143 of the PC 10 according to the first embodiment determines that the microphone MIC1 or the speaker SPK1 is turned off again within a first predetermined time (specifically, N seconds) from a timing at which the microphone MIC1 or the speaker SPK1 is turned on, the cause determination unit 143 determines that the microphone MICA or the speaker SPK1 that was turned off again is a howling cause. When the cause determination unit 143 of the PC 10 according to the first embodiment determines that the microphone MIC1 that is an example of a device connected to a voice input terminal or the speaker SPK1 that is an example of a device connected to a voice output terminal is turned off again within a first predetermined time (specifically, N seconds) from a timing at which the microphone MIC1 or the speaker SPK1 is turned on, the cause determination unit 143 determines that the microphone MIC1 or the speaker SPK1 that was turned off again is a howling cause. Accordingly, when the PC 10 according to the first embodiment detects that howling occurs again after a user turns on the device that is a howling cause, the PC 10 can determine that the device that was turned on by a user operation is a howling cause.

As described above, when the voice signal processing unit 141 of the PC 10 according to the first embodiment determines that the microphone MIC1 or the speaker SPK1 that was turned on is not turned off again within the first predetermined time (specifically, N seconds) from the timing at which the microphone MIC1 or the speaker SPK 1 is turned on, the voice signal processing unit 141 detects whether there is howling within a second predetermined time from the time when the microphone MIC1 or the speaker SPK1 is turned on. When howling is detected within the second predetermined time (specifically, M seconds) by the voice signal processing unit 141, the cause determination unit 143 determines that the microphone MIC1 or the speaker SPK1 that was turned on is a howling cause. When the voice signal processing unit 141 of the PC 10 according to the first embodiment determines that the microphone MIC1 that is an example of a device connected to a voice input terminal and was turned on or the speaker SPK1 that is an example of a device connected to a voice output terminal and was turned on is not turned off again within the first predetermined time (specifically, N seconds) from the timing at which the microphone MIC1 or the speaker SPK 1 is turned on, the voice signal processing unit 141 detects whether there is howling within a second predetermined time from the time when the microphone MIC1 or the speaker SPK1 is turned on. When howling is detected within the second predetermined time (specifically, M seconds) by the voice signal processing unit 141, the cause determination unit 143 determines that the microphone MIC1 or the speaker SPK1 that was turned on is a howling cause. As a result, the PC 10 according to the first embodiment can determine that a device that was turned off again by a user operation is a howling cause.

As described above, when the cause determination unit 143 of the PC 10 according to the first embodiment determines that the speaker phone DV1 is connected to the own terminal, the cause determination unit 143 determines that the own terminal is a main terminal. As a result, PC 10 according to the first embodiment can easily determine a main terminal in the own base based on the presence or absence of the speaker phone.

As described above, the cause determination unit 143 of the PC 10 according to the first embodiment acquires a connection order of the own terminal that is connected to the network NW1 among the own base terminal (that is, the PC 10, the PC 20, or the like arranged in the own base), and determines that the own terminal is a main terminal when it is determined that the connection order of the own terminal is a first one. As a result, the PC 10 according to the first embodiment can easily determine a main terminal in the own base.

As described above, when the cause determination unit 143 of the PC 10 according to the first embodiment determines that the connection order is the first one, the cause determination unit 143 further determines Whether both the microphone MIC1 and the speaker SPK1 are turned on. When the cause determination unit 143 determines that both the microphone MIC1 and the speaker SPK1 are turned on, the cause determination unit 143 determines that the own terminal is a main terminal. When the cause determination unit 143 of the PC 10 according to the first embodiment determines that the connection order is the first one, the cause determination unit 143 further determines whether both the microphone MIC1 that is an example of a device connected to a voice input terminal and the speaker SPK1 that is an example of a device connected to a voice output terminal are turned on. When the cause determination unit 143 determines that both the microphone MIC1 and the speaker SPK1 are turned on, the cause determination unit 143 determines that the own terminal is a main terminal. As a result, the PC 10 according to the first embodiment can easily determine a main terminal in the own base.

As described above, when it is determined that the speaker phone DV1 is connected to the own terminal, the cause determination unit 143 of the PC 10 according to the first embodiment determines that the PC 10 is a main terminal. Accordingly, the PC 10 according to the first embodiment can determine that the own base is a main terminal at a timing when speaker phone DV1 is connected to the own terminal.

As described above, after it is determined that the own terminal is not a main terminal, when it is determined that the speaker phone DV1 is connected to the own terminal, the cause determination unit 143 of the PC 10 according to the first embodiment determines that the own terminal is not a main terminal. As a result, the PC 10 according to the first embodiment can reduce the number of changes of a terminal to be set as a main terminal during a web conference.

As described above, after it is determined that the own terminal is not a main terminal, when it is determined that the speaker phone DV1 is connected to the own terminal, the cause determination unit 143 of the PC 10 according to the first embodiment determines that the own terminal is a main terminal. As a result, the PC 10 according to the first embodiment can adaptively change a terminal to be set as a main terminal during a web conference.

As described above, the cause determination unit 143 of the PC 10 according to the first embodiment determines that the own terminal is not a main terminal when the other terminal status information (an example of new connection information) indicating a new speaker phone is connected is acquired from another own base terminal (that is, another terminal such as the PC 20) that is different from the own terminal. As a result, the PC 10 according to the first embodiment can adaptively change a terminal to be set as a main terminal during a web conference.

As described above, the PC 10 according to the first embodiment further includes the own base connected terminal number determination unit 143C (an example of a connected terminal number determination unit) that causes the speaker SPK1 to play back a specific signal (an example of a specific voice) in a predetermined frequency band (for example, 20 kHz or more), detects a voice signal in the predetermined frequency band from a first voice signal collected by the microphone MIC1, and determines whether there is another own base terminal (that is, another terminal such as the PC 20) that is different from the own terminal based on the specific signal (the specific voice) included in the detected voice signal in the predetermined frequency band. When the own base connected terminal number determination unit 143C determines that there is another own base terminal, the voice signal processing unit 141 detects whether there is howling. The PC 10 according to the first embodiment further includes the own base connected terminal number determination unit 143C (an example of a connected terminal number determination unit) that causes the speaker SPK1 which is an example of a device connected to a voice output terminal to play back a specific signal (an example of a specific voice) in a predetermined frequency band (for example, 20 kHz or more), detects a voice signal in the predetermined frequency band from a first voice signal collected by the microphone MIC1 that is an example of a device connected to a voice input terminal, and determines whether there is another own base terminal (that is, another terminal such as the PC 20) that is different from the own terminal based on the specific signal (the specific voice) included in the detected voice signal in the predetermined frequency band. When the own base connected terminal number determination unit 143C determines that there is another own base terminal, the voice signal processing unit 141 detects whether there is howling. As a result, the PC 10 according to the first embodiment can determine whether a terminal (that is, another terminal) that may cause howling is arranged in the own base. When the PC 10 determines that the terminal arranged in the own base is only the own terminal, the PC 10 can omit the howling detection processing.

As described above, the own base connected terminal number determination unit 143C of the PC 10 according to the first embodiment calculates a hash value of the own terminal and determines a frequency of the specific signal (the specific voice) based on the calculated hash value. As a result, in a processing of determining the frequency of the specific voice, the PC 10 according to the first embodiment can easily determine a frequency different from the frequency of the specific voice that is played back from another terminal arranged in the own base.

Although various embodiments are described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that such changes also belong to the technical scope of the present disclosure. Components in various embodiments described above may be combined optionally in a range without deviating from the spirit of the invention.

### INDUSTRIAL APPLICABILITY

The present disclosure is useful as a voice communication apparatus and a howling detection method for specifying and presenting a cause of howling that may occur between the voice communication apparatus and another voice input and output device.

What is claimed is:

1. A voice communication apparatus configured to be connected to a voice conference in which a plurality of terminals participate, in each of the terminals, a voice input and a voice output being arbitrarily controlled to ON/OFF by a user operation, the voice communication apparatus comprising:
a communication unit configured to communicate with one or more another terminals via a network;
a voice signal processing unit configured to acquire a first voice signal collected from a voice input terminal, acquire a second voice signal that is output from another terminal and is input to a voice output terminal, and detect whether there is howling based on the first voice signal and the second voice signal;
a control unit configured to determine whether a device connected to the voice input terminal or a device connected to the voice output terminal is a howling cause based on a detection result of the voice signal processing unit; and
an alert notification unit configured to generate and output an alert screen when the control unit determines that the device connected to the voice input terminal or the device connected to the voice output terminal is the howling cause.

2. The voice communication apparatus according to claim 1,
wherein at least one own base terminal including the voice communication apparatus is connected to the network, and is arranged in an own base in which the voice communication apparatus is arranged,
wherein the control unit determines whether the voice communication apparatus among the own base terminals is a main terminal, and
wherein when it is determined that the voice communication apparatus is not the main terminal, the control unit determines whether the device connected to the voice input terminal or the device connected to the voice output terminal is turned on, and according to the determination, the control unit determines that the device connected to the voice input terminal or the device connected to the voice output terminal that were determined to be turned on is a howling cause.

3. The voice communication apparatus according to claim 2,
wherein the communication unit acquires howling information detected by another own base terminal that is different from the voice communication apparatus, wherein the control unit determines whether voice communication apparatus is the main terminal based on the acquired howling information, and
wherein when it is determined that the voice communication apparatus is not the main terminal, the control unit determines the howling cause.

4. The voice communication apparatus according to claim 1, further comprising:
an input unit configured to receive a user operation on the device connected to the voice input terminal or the device connected to the voice output terminal that is provided in the voice communication apparatus,
wherein the alert notification unit generates and outputs an instruction screen for instructing to turn off the device connected to the voice input terminal or the device connected to the voice output terminal that was determined to be the howling cause.

5. The voice communication apparatus according to claim 4,
wherein the voice signal processing unit detects whether there is howling again when it is determined that the device connected to the voice input terminal or the device connected to the voice output terminal that was determined to be the howling cause is turned off by the user operation.

6. The voice communication apparatus according to claim 5,
wherein when the voice signal processing unit determines that no howling is detected again, the control unit determines that the device connected to the voice input terminal or the device connected to the voice output terminal that was turned off is the howling cause.

7. The voice communication apparatus according to claim 4,
wherein after the device connected to the voice input terminal or the device connected to the voice output terminal is turned off by the user operation, when it is determined that the device connected to the voice input terminal or the device connected to the voice output terminal that was determined to be the howling cause is turned on by the user operation, the control unit outputs information about the device connected to the voice input terminal or the device connected to the voice output terminal to the alert notification unit, and
wherein the alert notification unit generates and outputs an alert message for warning re-occurrence of the howling based on the information.

8. The voice communication apparatus according to claim 7,
wherein the control unit determines whether a pointer position based on the user operation is located in the vicinity of an icon for turning on the device connected to the voice input terminal or the device connected to the voice output terminal that was determined to be the howling cause, and
wherein when it is determined that the pointer position is located in the vicinity of the icon, the alert notification unit outputs the alert message.

9. The voice communication apparatus according to claim 7,
wherein when the control unit determines that the device connected to the voice input terminal or the device connected to the voice output terminal is turned off again within a first predetermined time from a timing when the device connected to the voice input terminal or the device connected to the voice output terminal is turned on, the control unit determines that the device connected to the voice input terminal or the device connected to the voice output terminal that was turned off again is the howling cause.

10. The voice communication apparatus according to claim 7,
wherein when it is determined that the device connected to the voice input terminal or the device connected to the voice output terminal that was turned on is not turned off again within a first predetermined time from the timing when the device connected to the voice input terminal or the device connected to the voice output terminal is turned on, the voice signal processing unit detects whether there is howling within a second predetermined time from the timing when the device connected to the voice input terminal or the device connected to the voice output terminal is turned on, and
wherein when the voice signal processing unit detects the howling within the second predetermined time, the control unit determines that the device connected to the voice input terminal or the device connected to the voice output terminal that was turned on is a howling cause.

11. The voice communication apparatus according to claim 2,
wherein when it is determined that a speaker phone is connected to the voice communication apparatus, the control unit determines that the voice communication apparatus is the main terminal.

12. The voice communication apparatus according to claim 2,
wherein the control unit acquires a connection order in which the voice communication apparatus among the own base terminals is connected to the network, and
wherein when it is determined that the connection order is the first one, the control unit determines that the voice communication apparatus is the main terminal.

13. The voice communication apparatus according to claim 12,
wherein when it is determined that the connection order is the first one, the control unit further determines whether both the device connected to the voice input terminal and the device connected to the voice output terminal are turned on, and
wherein when it is determined that both the device connected to the voice input terminal and the device connected to the voice output terminal are turned on, the control unit determines that the voice communication apparatus is the main terminal.

14. The voice communication apparatus according to claim 2,
wherein when it is determined that a speaker phone is connected to the voice communication apparatus, the control unit determines that the voice communication apparatus is the main terminal.

15. The voice communication apparatus according to claim 2,
wherein after the control unit determines that the voice communication apparatus is not the main terminal, when the control unit determines that a speaker phone is connected to the voice communication apparatus, the control unit determines that the voice communication apparatus is not the main terminal.

16. The voice communication apparatus according to claim 2,
wherein after the control unit determines that the voice communication apparatus is not the main terminal, when the control unit determines that a speaker phone is connected to the voice communication apparatus, the control unit determines that the voice communication apparatus is the main terminal.

17. The voice communication apparatus according to claim 2,
wherein when the control unit acquires new connection information indicating a new speaker phone is connected from another own base terminal that is different from the voice communication apparatus, the control unit determines that the voice communication apparatus is not the main terminal.

18. The voice communication apparatus according to claim 2, further comprising:
a connected terminal number determination unit configured to cause the device connected to the voice output terminal to play back a specific signal in a predetermined frequency band, detect a voice signal in the predetermined frequency band from the first voice signal collected by the device connected to the voice input terminal, and determine whether there is another own base terminal that is different from the voice communication apparatus based on the specific signal included in the detected voice signal in the predetermined frequency band,
wherein when the connected terminal number determination unit determines that there is the another own base terminal, the voice signal processing unit detects whether there is howling.

19. The voice communication apparatus according to claim 18,
wherein the connected terminal number determination unit calculates a hash value of the voice communication apparatus, and determines a frequency of the specific signal based on the calculated hash value.

20. A howling detection method to be executed by a voice communication apparatus configured to be connected to a voice conference in which a plurality of terminals participate, in each of the terminals, a voice input and a voice output being freely controlled to ON/OFF by a user operation, the howling detection method comprising:
communicating with one or more another terminals via a network;
acquiring a first voice signal collected from a device connected to a voice input terminal, acquiring a second voice signal that is output from another terminal and is input to a device connected to a voice output terminal, and detecting whether there is howling based on the first voice signal and the second voice signal;
determining whether the device connected to the voice input terminal or the device connected to the voice output terminal is a howling cause; and
generating and outputting an alert screen when it is determined that the device connected to the voice input terminal or the device connected to the voice output terminal is the howling cause.
